(19) United States
(12) Patent Application Publication
(10) Pub. No.: US 2026/0152286 A1
(43) Pub. Date: Jun. 4, 2026

(54) SYSTEMS AND METHODS FOR CONTROLLING AIRCRAFT SUBSYSTEMS IN DIFFERENT MODES AND STATES

(71) Applicant: Archer Aviation Inc., San Jose, CA (US)

(72) Inventors: Pedro CARLEIAL, Los Altos Hills, CA (US); Saienath POOPALARAJAH, San Jose, CA (US); Nicholas KIRATZIS, Mountain View, CA (US); Fernanda Aline Matta DE PAIVA, Los Altos Hills, CA (US); Katarina MOROWSKY, Wentworth, GA (US); Daniel Kenji NISHIMARU, Quebec (CA); Paul FRIHAUF, San Jose, CA (US); Allen IBARA, Portola Valley, CA (US); Damien BARDON, San Jose, CA (US)

(73) Assignee: Archer Aviation Inc., San Jose, CA (US)

(21) Appl. No.: 19/460,182

(22) Filed: Jan. 26, 2026

Related U.S. Application Data
(63) Continuation of application No. PCT/US2024/029122, filed on May 13, 2024.
Application No. PCT/US2024/029122 is a continuation-in-part of application No. PCT/US2023/079690, filed on Nov. 14, 2023.
(60) Provisional application No. 63/383,660, filed on Nov. 14, 2022.
(60) Provisional application No. 63/608,107, filed on Dec. 8, 2023.
(60) Provisional application No. 63/616,316, filed on Dec. 29, 2023.

(51) Int. Cl. B64D 31/16

(52) U.S. Cl. CPC B64D 31/16; B64D 2221/00

(57) ABSTRACT

A computer-implemented method of controlling aircraft power distribution, comprising: receiving, at a control circuit in an aircraft, a selection of one of at least three aircraft modes of operation from a user input device, determining, upon receiving the selection of the selected mode and via the control circuit, whether one or more conditions are met, and controlling, upon determining the one or more conditions are met and via the control circuit, power distribution within the aircraft based on the selected mode of operation, wherein controlling power distribution based on the selected mode of operation comprises: separately controlling via the control circuit, based on the selected mode of operation, high voltage power to at least one electric propulsion unit and high voltage power to at least one non-propulsion load.

### CROSS-REFERENCE TO RELATED APPLICATIONS

This disclosure claims priority to U.S. Provisional Application No. 63/608,107, titled “AIRCRAFT MODES AND STATES,” filed Dec. 8, 2023, (previously Attorney Docket No. 16163.6029-00000, and now Attorney Docket No. 16499.6010-00000), and U.S. Provisional Application No. 63/616,316, titled “BATTERY MANAGEMENT SYSTEM”, filed Dec. 29, 2023, (Attorney Docket No. 16497.6005-00000), and PCT Application PCT/US23/79690, titled “High Voltage Battery Architecture”, filed Nov. 14, 2023, (Attorney Docket No. 16163.0018-00304), which in turn claims priority to and the benefit of U.S. Provisional Application No. 63/383,660, titled “Systems and Methods for Improved Battery Assemblies for eVTOL Aircraft.”, filed Nov. 14, 2022, (Attorney Docket No. 16163.6005-00000). The entire contents of the aforementioned applications are incorporated by reference herein for all purposes.

### TECHNICAL FIELD

This disclosure relates generally to the field of powered aerial vehicles. More particularly, and without limitation, the present disclosure relates to innovations in aircraft that use electrical propulsion systems. Certain aspects of the present disclosure generally relate to transitioning between different aircraft modes based on user selections. Other aspects of the present disclosure generally relate to transitioning between different aircraft states, within a set mode, based on detecting certain events.

### BACKGROUND

The inventors here have recognized several problems that may be associated with controlling subsystems of an aircraft, including an aircraft that uses electric or hybrid-electric propulsion systems (hereinafter referred to as electric propulsion units or “EPUs”). For example, there is a need to configure aircraft power supply (e.g., battery packs) and circuitry to provide for redundancy, fault tolerance, energy efficiency, and weight efficiency. Further, a user may desire to switch an aircraft's mode or state of operation without turning on and off various subsystems. When switching to a different mode or state, it is desirable to disable unnecessary components to conserve energy and preserve the lifespan and integrity of the components.

### SUMMARY

The present disclosure relates generally to configuration and control of aircraft subsystems. More particularly, and without limitation, the present disclosure relates to innovations in aircraft that use electric or hybrid-electric propulsion systems. Certain aspects of the present disclosure relate to circuitry and component arrangements that provide for redundancy, fault tolerance, energy efficiency, and weight efficiency. Other aspects of the present disclosure relate to safely controlling an aircraft's subsystems by confirming certain conditions are met prior to switching aircraft modes. Further aspects of the present disclosure relate to control sequences and circuitry configurations that allow enabling and disabling subsystems while maintaining power to critical subsystems.

One aspect of the present disclosure is directed to a method of controlling aircraft power distribution, comprising: receiving, at a control circuit in an aircraft, a selection of one of at least three aircraft modes of operation from a user input device, and controlling, via the control circuit, power distribution within the aircraft based on the selected mode of operation, wherein controlling power distribution based on the selected mode of operation comprises: separately controlling via the control circuit, based on the selected mode of operation, high voltage power to at least one electric propulsion unit and high voltage power to at least one non-propulsion load.

Another aspect of the present disclosure is directed to a system for an aircraft, the system comprising: a battery management unit, one or more battery cells configured to supply high voltage power, at least one first switching device configured to enable and disable power supply from a charging port to the one or more battery cells, at least one second switching device configured to enable and disable a power supply from the one or more battery cells to a non-propulsion load, and at least one third switching device configured to enable and disable a power supply from the one or more battery cells to electric propulsion units of the aircraft. The battery management unit controls the first, second, and third switching devices based on a selection of one of at least three aircraft modes of operation received from a user input device.

A further aspect of the present disclosure is directed to a system for an aircraft, the system comprising: a user input device configured to receive an input indicating a mode of operation, a power switching device configured to provide power to a controller upon receiving a signal from the user input device, and a controller configured to control power to one or more subsystems of the aircraft. The user input device is configured: to not send the signal to the power switching device when the received input indicates a first mode of operation, to send the signal to the power switching device when the received input indicates a second mode of operation, to send the signal to the power switching device when the received input indicates a third mode of operation, and to not send the signal to the power switching device when the received input indicates a fourth mode of operation.

### BRIEF DESCRIPTION OF FIGURES

FIG. 1A illustrates an example eVTOL aircraft, consistent with embodiments of the present disclosure.

FIG. 1B illustrates another example eVTOL aircraft, consistent with embodiments of the present disclosure.

FIGS. 1C, 1D, 1E, 1F, 1G and 1H illustrate exemplary top plan views of aircraft, consistent with disclosed embodiments.

FIG. 1I illustrates an example eVTOL aircraft and associated subsystems, consistent with embodiments of the present disclosure.

FIGS. 1J, 1K, and 1L illustrate exemplary connections to subsystems, consistent with embodiments of the present disclosure.

FIG. 2A illustrates exemplary modes of an aircraft, consistent with embodiments of the present disclosure.

FIGS. 2B, 2C, 2D, and 2E illustrate exemplary power connections associated with modes of an aircraft, consistent with embodiments of the present disclosure.

FIG. 3A illustrates a diagram of exemplary aircraft circuity, consistent with embodiments of the present disclosure.

FIG. 3B illustrates a diagram of exemplary aircraft circuity, consistent with embodiments of the present disclosure.

FIG. 3C illustrates a diagram of an exemplary mode switch, consistent with embodiments of the present disclosure.

FIG. 3D illustrates another diagram of an exemplary mode switch, consistent with embodiments of the present disclosure.

FIG. 4 illustrates a flow chart of an exemplary process for switching aircraft modes, consistent with embodiments of the present disclosure.

FIG. 5 illustrates a flow chart of an exemplary process for switching aircraft states, consistent with embodiments of the present disclosure.

### DETAILED DESCRIPTION

The present disclosure addresses systems, components, and techniques primarily for use in an aircraft. The aircraft may be an aircraft with a pilot, an aircraft without a pilot (e.g., a UAV), a drone, a helicopter, and/or an airplane. An aircraft includes a physical body and one or more components (e.g., a wing, a tail, a propeller) configured to allow the aircraft to fly. The aircraft may include any configuration that requires power to one or more subsystems of the aircraft.

Disclosed embodiments provide new and improved configurations of aircraft components, some of which are not observed in conventional aircraft, and/or identified design criteria for components that differ from those of conventional aircraft. Such alternate configurations and design criteria, addressing drawbacks and challenges with conventional components, yielded the embodiments disclosed herein for various configurations and designs of components for an aircraft (e.g., electric aircraft or hybrid-electric aircraft) driven by a propulsion system.

Embodiments may include an electric propulsion system, including an electric engine connected to an onboard electrical power source. A power source may include a device capable of storing energy such as a battery or capacitor, and may optionally include one or more systems for harnessing or generating electricity such as a fuel powered generator or solar panel array. In some embodiments, the aircraft may comprise a hybrid aircraft using at least one of an electric-based energy source or a fuel-based energy source to power the distributed propulsion system. In some embodiments, the aircraft may be powered by one or more batteries, internal combustion engines (ICE), generators, turbine engines, or ducted fans.

In some embodiments, an electric propulsion system as described herein may generate thrust by supplying High Voltage (HV) electric power to an electric engine, which in turn converts HV power into mechanical shaft power which is used to rotate a propeller. The aircraft as described herein may possess multiple electric engines. The amount of thrust each electric engine generates may be governed by a torque command from the Flight Control System (FCS) over a digital communication interface to each electric engine.

Embodiments of the present disclosure implement improved system redundancy in the case of a failure, to minimize any single points of failure in the aircraft propulsion system. Some disclosed embodiments also provide new and improved approaches to satisfying aviation and transportation laws and regulations.

Aircrafts need to be lightweight enough meet their performance goals. Extra weight on an aircraft may impact its ability to generate enough lift (e.g. through static and/or powered lift elements) to fly safely. Further, extra weight can negatively affect an aircraft's maneuverability, speed, climb rate, and range. It is particularly important that electric aircrafts avoid extra weight. Unlike a conventional aircraft, electric aircrafts are unable to store extra fuel. Instead, an electric aircraft's energy supply is limited to the energy capacity of its battery packs.

Battery packs are one of the main contributors to the weight of an electric aircraft. An electric aircraft may include multiple high voltage battery packs to power one or more electric engines and/or tilt actuators. For example, an electric aircraft may include four, six, eight, ten, or twelve, or any number, of battery packs to power the aircraft's electric engines and/or tilt actuators. One or more additional battery packs (e.g. low voltage battery packs) may power low voltage systems, such as the flight control system, charging control equipment, environmental conditioning systems, and/or other auxiliary loads. However, these additional battery packs add weight and take up space within an aircraft.

Embodiments of the present disclosure help to solve this problem, and others, by powering the low voltage distribution system with the one or more high voltage battery packs which also power the electric engines and/or tilt actuators. In some embodiments, one or more DC/DC converters are configured to step down the high voltage power to feed the low voltage distribution system. Therefore, the number of battery packs may be reduced and/or the need for low voltage battery packs may be eliminated.

Further, embodiments of the present disclosure provide for arrangements of components and circuitry that allow for separate control of power to different loads (e.g., low voltage system, electric engines etc.), improving energy efficiency. Embodiments of the present disclosure also provide for redundancy and fault tolerance by balancing backup power and electrical separation between critical components.

Further, embodiments of the present disclosure allow a pilot to control an aircraft in different modes with certain subsystems enabled or disabled. For example, a pilot may want to control an aircraft in different modes, such as an “off” mode, a “service mode”, a “ground mode”, and/or a “fly” mode, with different subsystems enabled (e.g., for each mode). However, it may be difficult for the pilot to switch on and off different subsystems. The present disclosure solves this problem, and others, by providing a mode switch that automatically enables and/or disables different subsystems based on the selected mode. Further, within each mode, an aircraft may be automatically controlled into different states based on detecting an event.

Further, embodiments of the present disclosure help to limit the operational hours of an aircraft's critical systems, such as the flight control system (FCS). Limiting operational hours of the FCS may help to preserve the integrity of the FCS and/or comply with regulatory requirements. The present disclosure solves this problem, and others, by disabling the FCS in certain modes and/or states and relying on other controller(s) (e.g. a charge control unit) to communicate with various subsystems. For example, in some embodiments, the FCS may be disabled in “off” mode and “service” mode, unless a maintenance state is selected and/or a ground unit provides power to the low voltage distribution system. Limiting usage of the FCS may also reduce unnecessary power consumption.

Further, embodiments of the present disclosure help to limit the operational hours of other low voltage components, such as low voltage system control unit(s) and/or low voltage power distribution unit(s) to preserve their integrity. The present disclosure solves this problem, and others, by disabling other low voltage components in certain modes and/or states. For example, in some embodiments, low voltage components may be disabled in an “off” mode and a “service” mode, unless a maintenance state is selected and/or a ground unit provides power to the low voltage distribution system. Limiting usage of the low voltage components may also reduce unnecessary power consumption.

The present disclosure further allows for charging in certain modes with the FCS and/or other low voltage components disabled. For example, in some embodiments, the FCS and/or other low voltage components may be disabled in an “off” mode and a “service” mode and a charging state may be allowed in those modes. Therefore, aircraft charging may occur (e.g. overnight) without adding additional operational hours on the FCS and/or other low voltage components.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the subject matter recited in the appended claims.

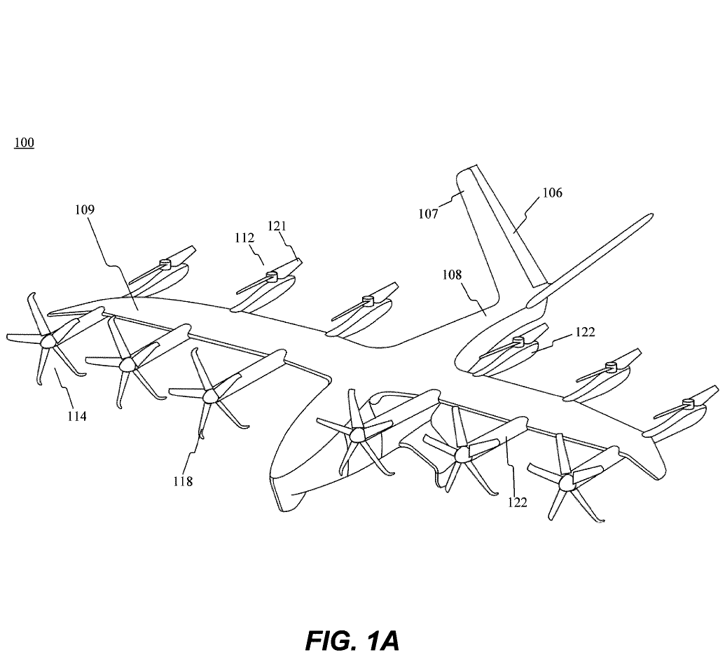

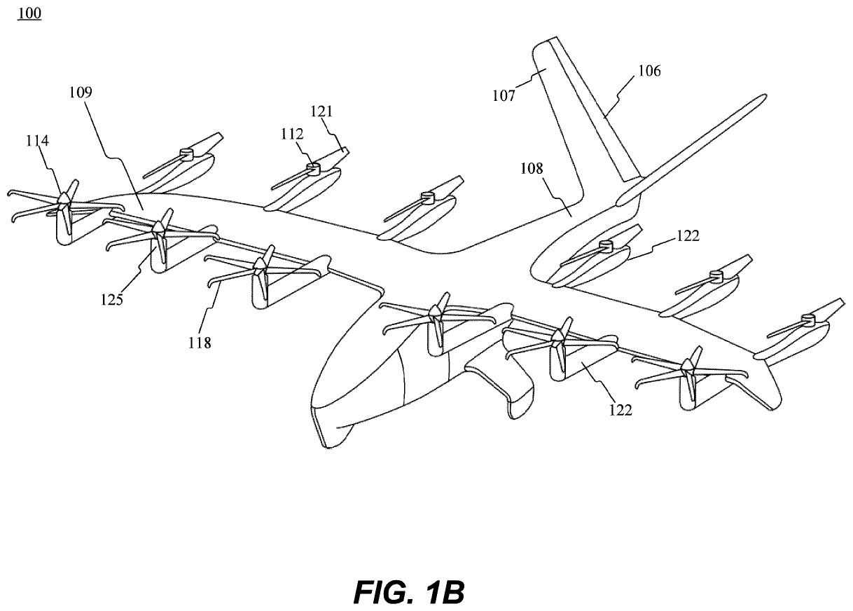

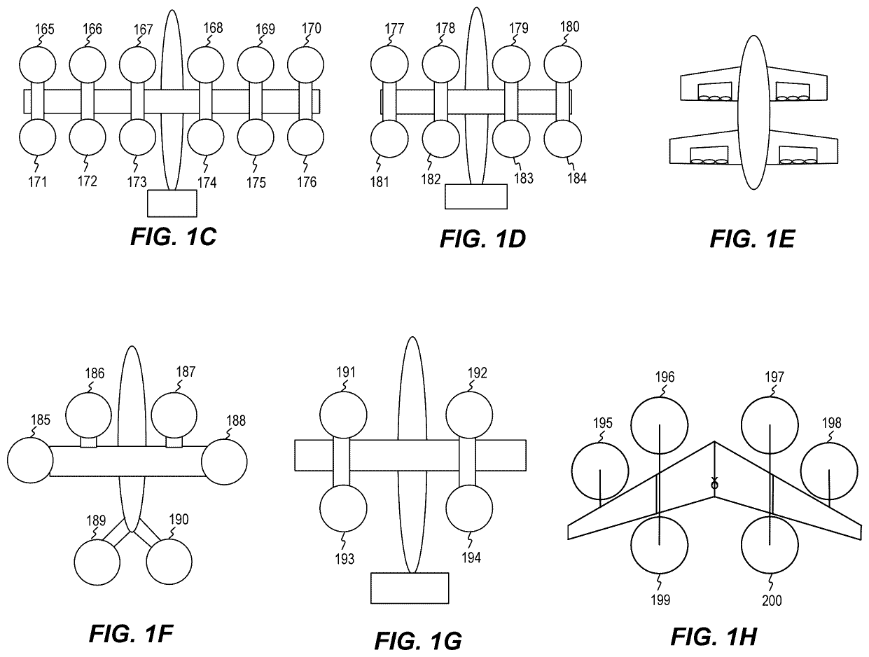

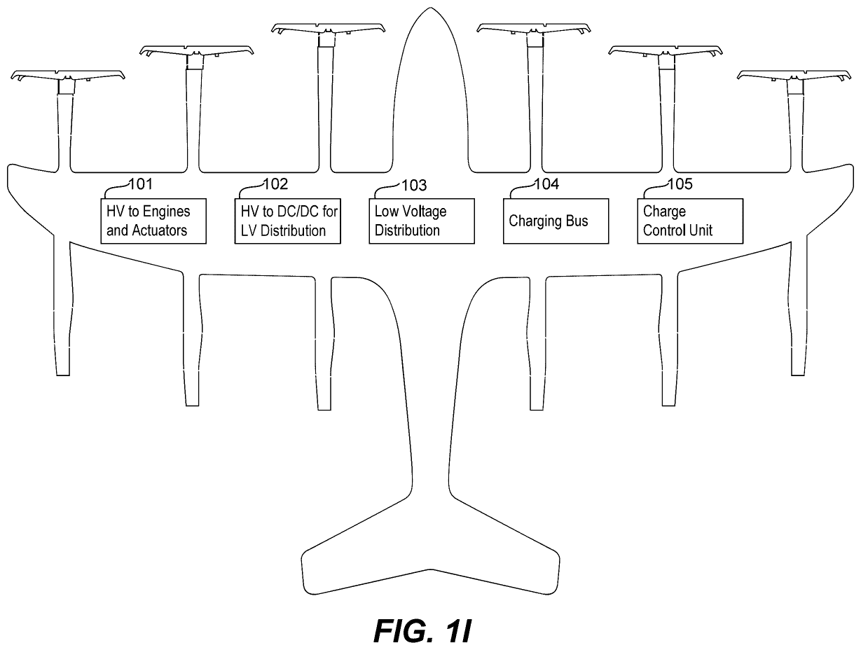

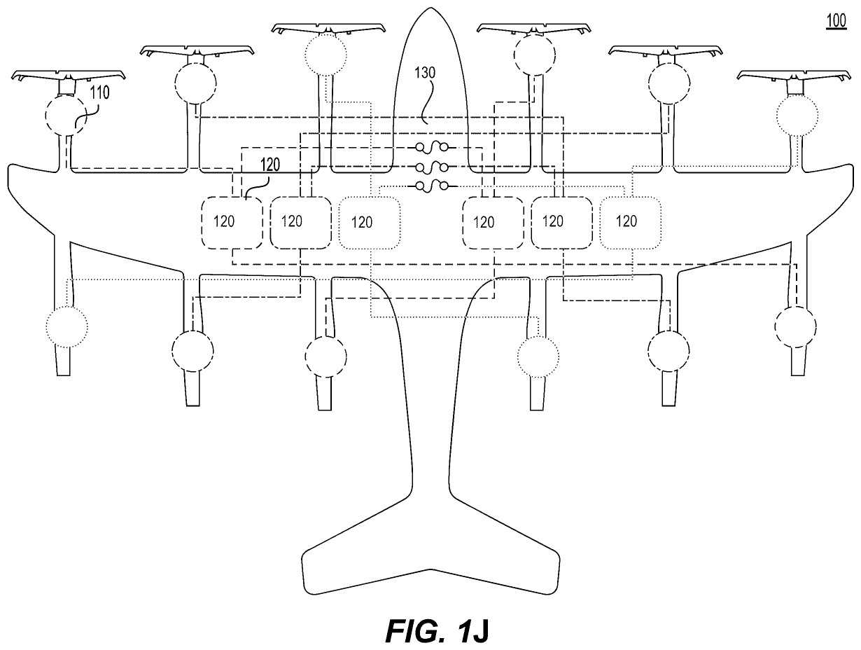

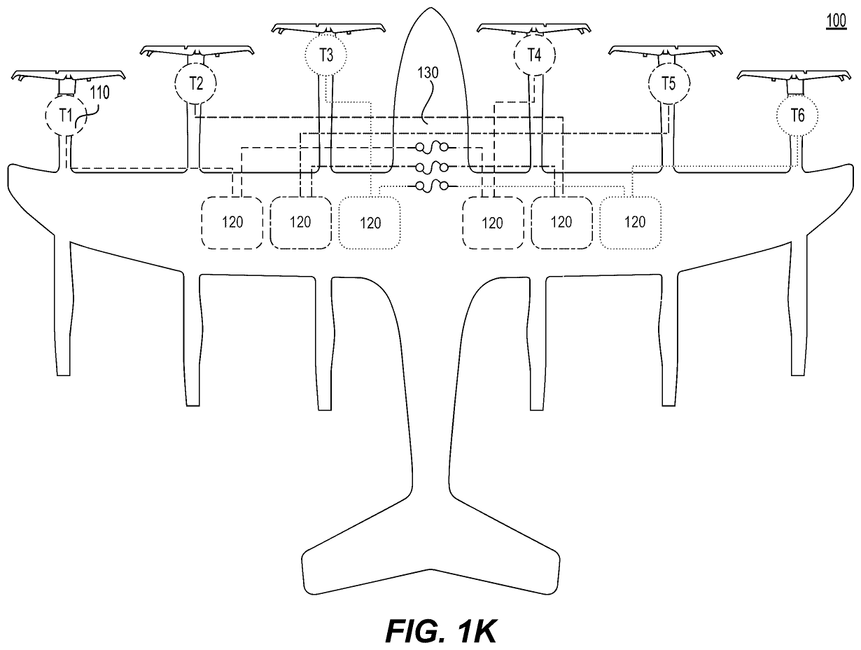

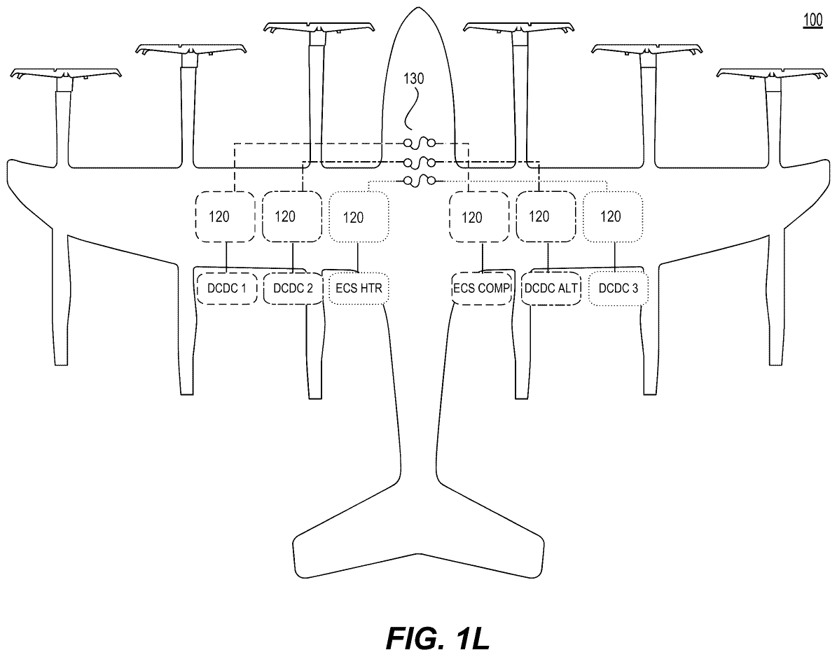

FIGS. 1A-B illustrate a VTOL aircraft 100 in a cruise configuration and a vertical take-off, landing and hover configuration (also referred to herein as a “lift” configuration), respectively, consistent with embodiments of the present disclosure. The aircraft 100 may include a fuselage 108, wings 109 mounted to the fuselage 108, tail 107, and one or more rear stabilizers 106 mounted to the tail 107 or the rear of the fuselage 108. A plurality of lift propellers 112 may be mounted to wings 109 and configured to provide lift for vertical take-off, landing and hover. A plurality of tilt propellers 114 may be mounted to wings 109 and may be tiltable between the cruise configuration in which they provide forward thrust to aircraft 100 for horizontal flight, as shown in FIG. 1A, and the lift configuration in which they provide a portion of the lift required for vertical take-off, landing and hovering, as shown in FIG. 1B. As used herein, a lift configuration may refer to a tilt propeller orientation in which the tilt propeller thrust is providing primarily lift to the aircraft. A cruise configuration may refer to a tilt propeller orientation in which the tilt propeller thrust is providing primarily forward thrust to the aircraft. Alternatively, a cruise configuration may refer to a configuration in which a lift propeller is stowed.

In some embodiments, lift propellers 112 may be configured for providing lift only, with all propulsion being provided by the tilt propellers. Accordingly, lift propellers 112 may be in fixed positions and may only generate thrust during take-off, landing and hover. Meanwhile, tilt propellers 114 may be tilted to lift configurations in which their thrust is directed downwardly for providing additional lift.

For forward flight, tilt propellers 114 may tilt from their lift configurations to their cruise configurations. In other words, the pitch and tilt angle of tilt propellers 114 may be varied from an orientation in which the tilt propeller thrust is directed downward (to provide lift during vertical take-off, landing and hover) to an orientation in which the tilt propeller thrust is directed rearward (to provide forward thrust to aircraft 100). The tilt propellers may tilt about axes that may be perpendicular to the forward direction of the aircraft 100. When the aircraft 100 is in full forward flight during the cruise configuration, lift may be provided entirely by wings 109. Meanwhile, lift propellers 112 may be shut off. The blades 121 of lift propellers 112 may be locked in low-drag positions for aircraft cruising. In some embodiments, lift propellers 112 may each have two blades 121 that may be locked for cruising in minimum drag positions in which one blade is directly in front of the other blade as illustrated in FIG. 1A. In some embodiments, lift propellers 112 have more than two blades. In some embodiments, tilt propellers 114 include more blades 118 than lift propellers 112. For example, as illustrated in FIGS. 1A-B, lift propellers 112 may each include, e.g., two blades and tilt propellers 114 may each include, e.g., five blades. In some embodiments, tilt propellers 114 may have, e.g., from 2 to 5 blades.

In some embodiments, the aircraft may include only one wing 104 on each side of fuselage 108 (or a single wing that extends across the entire aircraft) and at least a portion of lift propellers 112 may be located rearward of wings 109 and at least a portion of tilt propellers 114 may be located forward of wings 109. In some embodiments, all of lift propellers 112 may be located rearward of wings 109 and all of tilt propellers 114 may be located forward of wings 109. According to some embodiments, all lift propellers 112 and tilt propellers 114 may be mounted to the wings—i.e., no lift propellers or tilt propellers may be mounted to the fuselage. In some embodiments, lift propellers 112 may be all located rearwardly of wings 109 and tilt propellers 114 may be all located forward of wings 109. According to some embodiments, all lift propellers 112 and tilt propellers 114 may be positioned inwardly of the wing tips 109.

In some embodiments, lift propellers 112 and tilt propellers 114 may be mounted to wings 109 by booms 122. Booms 122 may be mounted beneath wings 109, on top of the wings, and/or may be integrated into the wing profile. In some embodiments, one lift propeller 112 and one tilt propeller 114 may be mounted to each boom 122. Lift propeller 112 may be mounted at a rear end of boom 122 and tilt propeller 114 may be mounted at a front end of boom 122. In some embodiments, lift propeller 112 may be mounted in a fixed position on boom 122. In some embodiments, tilt propeller 114 may mounted to a front end of boom 122 via a hinge. Tilt propeller 114 may be mounted to boom 122 such that tilt propeller 114 is aligned with the body of boom 122 when in the cruise configuration, forming a continuous extension of the front end of boom 122 that minimizes drag for forward flight.

In some embodiments, aircraft 100 may include, e.g., one wing on each side of fuselage 108 or a single wing that extends across the aircraft. According to some embodiments, the at least one wing 104 is a high wing mounted to an upper side of fuselage 108. According to some embodiments, the wings include control surfaces, such as flaps, ailerons or flaperons. Further discussion of VTOL aircraft may be found in U.S. Patent Publication No. 2021/0362849, which is incorporated by reference in its entirety.

FIGS. 1C, 1D, 1E, 1F, 1G and 1H illustrate exemplary top plan views of aircraft, consistent with disclosed embodiments. There may be a number of design considerations (cost, weight, size, performance capability etc.) that may influence the number and/or combination of tilt (e.g., tiltable) and lift (e.g., nontiltable) propellers in an aircraft. The number and orientation of propulsion units may affect the number of battery packs and connections between battery packs (e.g., to achieve controllability and/or stability upon electric failure).

FIG. 1C illustrates an arrangement of electric propulsion units, consistent with embodiments of the present disclosure. Referring to FIG. 1C, the aircraft shown in the figure may be a top plan view of an exemplary aircraft. The aircraft may include twelve electric propulsion systems distributed across the aircraft. In some embodiments, a distribution of electric propulsion systems may include six forward electric propulsion systems (165, 166, 167, 168, 169, and 170) and six aft electric propulsion systems (171, 172, 173, 174, 175, and, 176). In some embodiments, the six forward electric propulsion systems may be operatively connected to tilt propellers and the six aft electric propulsion systems may be operatively connected to lift propellers. In other embodiments, the six forward electric propulsion systems and a number of aft electric propulsion systems may be operatively connected to tilt propellers and the remaining aft electric propulsion systems may be operatively connected to lift propellers. In other embodiments, all forward and aft electric propulsion systems may be operatively coupled to tilt propellers.

FIG. 1D illustrates an alternate arrangement of electric propulsion units, consistent with embodiments of the present disclosure. Referring to FIG. 1D, the aircraft shown in the figure may be a top plan view of an exemplary aircraft. The aircraft may include eight electric propulsion systems distributed across the aircraft. In some embodiments, a distribution of electric propulsion systems may include four forward electric propulsion systems (177, 178, 179, and 180) and four aft electric propulsion systems (181, 182, 183, and 184). In some embodiments, the four forward electric propulsion systems may be operatively connected to tilt propellers and the four aft electric propulsion systems may be operatively connected to lift propellers. In other embodiments, the four forward electric propulsion systems and a number of aft electric propulsion systems may be operatively connected to tilt propellers and the remaining aft electric propulsion systems may be operatively connected to lift propellers. In other embodiments, all forward and aft electric propulsion systems may be operatively coupled to tilt propellers.

FIG. 1E illustrates an alternate arrangement of electric propulsion units, consistent with the embodiments of the present disclosure. Referring to FIG. 1E, the aircraft may be a top plan view of an exemplary aircraft. In some embodiments, the aircraft may include ducted fans operably connected to the electric propulsion systems. In some embodiments the aircraft may include a bank of ducted fans on each wing of the aircraft and the bank of ducted fans may be connected to tilt together (e.g., between lift and forward thrust configuration). In some embodiments the aircraft includes a left and right front wing and a left and right rear wing. In some embodiments, each wing of the aircraft includes a bank of connected ducted fans. In some embodiments, each bank of connected ducted fans are tiltable (e.g., between lift and forward thrust), while in other embodiments only the bank of fans on the front wing(s) are tiltable.

FIG. 1F illustrates an alternate arrangement of electric propulsion units, consistent with embodiments of the present disclosure. Referring to FIG. 1F, the aircraft shown in the figure may be a top plan view of an exemplary aircraft. The aircraft may include six electric propulsion systems distributed across the aircraft. In some embodiments, a distribution of electric propulsion systems may include a first set of four electric propulsion systems 185, 186, 187, and 188 coplanar in a first plane and a second set of two electric propulsion systems 189 and 190 coplanar in a second plane. In some embodiments, the first set of electric propulsion systems 185, 186, 187, and 188 may be operatively connected to tilt propellers and second set of electric propulsion systems 189 and 190 may be operatively connected to lift propellers. In other embodiments, the first set of electric propulsion systems 185, 186, 187, and 188 and the second set of aft electric propulsion systems 189 and 190 may all be operatively connected to tilt propellers.

FIG. 1G illustrates an alternate arrangement of electric propulsion units, consistent with embodiments of the present disclosure. Referring to FIG. 1G, the aircraft shown in the figure may be a top plan view of an exemplary aircraft. The aircraft may include four electric propulsion systems distributed across the aircraft. In some embodiments, a distribution of electric propulsion systems may include four coplanar electric propulsion systems 191, 192, 193, and 194. In some embodiments, all of the electric propulsion systems may be operatively connected to tilt propellers.

FIG. 1H illustrates an alternate arrangement of electric propulsion units, consistent with embodiments of the present disclosure. Referring to FIG. 1H, the aircraft shown in the figure may be a top plan view of an exemplary aircraft (e.g., a VTOL aircraft). The aircraft may include six electric propulsion systems distributed across the aircraft. For example, in some embodiments, the aircraft may include four forward electric propulsion systems 195, 196, 197, and 198 operatively connected to tilt propellers and the two aft electric propulsion systems 199 and 200 operatively connected to lift propellers. In some embodiments, the aircraft may include ten electric propulsion systems distributed across the aircraft. For example, in some embodiments, the aircraft may include six forward electric propulsion systems operatively connected to tilt propellers and the four aft electric propulsion systems operatively connected to lift propellers. In some embodiments, some or all of the aft electric propulsion systems may operatively connected to tilt propellers.

As shown in FIG. 1H, in some embodiments, the aircraft may have a flying wing configuration, such as a tailless fixed-wing aircraft with no definite fuselage. In some embodiments, the aircraft may have a flying wing configuration with the fuselage integrated into the wing. In some embodiments, the tilt propellers may rotate in a plane above the body of the aircraft when the tilt propellers operate in a lift configuration.

FIG. 1I illustrates an example eVTOL aircraft and associated subsystems, consistent with embodiments of the present disclosure. Subsystem 101 is high voltage electrical circuitry and associated devices powering the electric engines and tilt actuators. Subsystem 102 is high voltage electrical circuitry and associated devices connected to DC/DC converters which step down the power to feed the low voltage distribution system. In some embodiments, each battery pack in an aircraft may provide power to both Subsystem 101 and Subsystem 102. In some embodiments, an arrangement of switching devices provide for separate control of power flow to Subsystem 101 and Subsystem 102.

Subsystem 103 is a low voltage power distribution system and associated devices. The low voltage power distribution system may be fed from Subsystem 102 through the DC/DC converters, as described above. For example, primary and/or alternate DC/DC converter(s) may perform the voltage conversion. In some embodiments, one alternate converter may provide low voltage power during power up of an aircraft and/or in the event of a failure of one or more primary DC/DC converters. Further, Subsystem 103 may be configured to accept power via a ground power unit. In some embodiments, only one of Subsystem 103 or Subsystem 104 may be configured to accept power from a ground unit at a time. In other embodiments, both subsystems may be configured to accept power from one or more ground units simultaneously.

The low voltage power distribution system, subsystem 103, may include a combination of power distribution boxes (PDBs) to manage and distribute low voltage power to different aircraft components. In some embodiments, the low voltage power distribution system may power all low voltage aircraft components. For example, the low voltage distribution system may power avionics, flight control computers, aircraft flight control surfaces, motors controllers, battery management systems for the battery packs, environmental control systems, sensors, medical equipment, and/or any other system on the aircraft requiring low voltage power. “High-voltage,” as used herein, refers to a voltage greater than 110 volts. “Low-voltage direct current (DC),” as used herein, refers to 33 VDC or lower. In some embodiments, low voltage refers to 28 VDC.

Subsystem 104 is a high voltage charging bus and associated devices connecting a charging port to one or more battery packs to allow the battery packs to be charged. In some embodiments, the high voltage charging bus may be electrically separate from other high voltage distribution. For example, the charging bus may be electrically separate from high voltage power to electric engines and actuators (Subsystem 101) and high voltage power to converters for low voltage distribution (Subsystem 102).

Subsystem 105 is a charge control unit (CCU). The CCU may control the battery packs during the charging process. For example, in some embodiments, the CCU may receive status updates from battery packs and provides commands to battery packs to control their charge level by opening and closing battery pack charge contactors. Further, in some embodiments, the CCU may send commands to one or more ground units, communicating the electrical charging requirements and/or cooling requirements of the battery packs.

Further, in some embodiments, the CCU may receive a selected mode and communicate with one or more components of the aircraft. For example, in some embodiments, the CCU may communicate the selected mode to one or more battery packs and control the battery packs as needed. In some embodiments, the communication lines between the CCU and battery packs may be used for both mode switch control and charge control. Therefore, the amount of wiring in the aircraft may be reduced. In other embodiments, a controller other than a CCU may receive the selected mode and perform the communications with the components of the aircraft. For example, in some embodiments the aircraft may include a central battery management unit and/or central battery management system that controls operations of all aircraft battery packs (e.g., sends contactor commands, monitors battery pack status etc.). The central battery management unit and/or battery management system may receive the selected mode and perform the communications detailed above. Further, a separate controller (e.g., a central battery management unit, or BMS) may control charging operations.

FIGS. 1J, 1K, and 1L illustrate exemplary connections to subsystems, consistent with embodiments of the present disclosure. FIG. 1J illustrates battery packs configured to power electric propulsion units and provide backup power for other battery packs. The configuration and control of the electric engines and propellers may match that of the aircraft described in FIGS. 1A-1B. The aircraft may include a high voltage power supply (HVPS) system to supply the High Voltage (HV) electric power. The HVPS system is the source of power on the aircraft and configured to distribute the stored electrical energy to other systems on the aircraft, including the electrical propulsion system (EPS) for converting electrical power into mechanical rotational shaft power to generate thrust. As shown, the HVPS system of the aircraft may include six battery packs 120 (which are numbered 1-6 from left to right) installed within the battery bays in the wing of the aircraft. The battery packs may power one or more electric engines 110. While six battery packs are shown, the aircraft 100 may have any number of battery packs.

In some embodiments, a single battery pack 120 may be electrically connected to, and power, multiple electric engines. For example, in some embodiments, a battery pack 120 may power an electric engine 110 on either side of a longitudinal axis. In some embodiments a battery pack 120 may power an electric engine on either side of a horizontal axis. In some embodiments, as shown, a battery pack 120 may power two diagonally opposing electric engines 110.

Further, the HVPS system includes a cross-link 130 (e.g., electrical connection between battery packs) possessing at least one fuse, allowing for pairing of two or more battery packs 120. Through the cross-link 130, power for the electric engines 110 can be shared among the paired battery packs 120. Therefore, multiple battery packs 120 can simultaneously power multiple electric engines 110. This arrangement provides for redundancy and avoids a single point of failure because each paired battery pack 120 may act as a backup for the other(s). Upon failure of a battery pack, one or more connected battery packs 120 may continue powering the failed battery pack's connected electric engines 110. In some embodiments, as shown, two battery packs 120 may be paired together, powering a total of four electric engines 110. However, the aircraft may include a different combination of electric engine and battery pack pairings.

### Alternate Battery Pack Arrangements

The above configuration is provided as an example, but a different number and configuration of battery packs, electric engines, battery pack to electric engine connections, and battery pack cross-link combinations may be used. In some embodiments, each battery pack may power an individual electric engine. For example, an aircraft may have four, six, eight, ten, twelve, or any number of electric engines and the number of battery packs may match the number of electric engines. In some embodiments, each battery pack may power only one electric engine and may be electrically separate from all other battery packs. In some embodiments, each battery pack may power one or more partial motors and each electric engine may include two or more partial motors. Therefore, each electric engine may have a backup power source, but the battery packs may still be electrically separate.

In some embodiments, each battery pack may power multiple electric engines. As described above, battery packs may power sets of electric engines that are symmetrical across one or more axes of symmetry. In some embodiments, a battery pack may power electric engines that are symmetrical across an aircraft's longitudinal axis, lateral axis, or both. For example, as described above, in some embodiments, different battery packs may power diagonally symmetric electric engines.

In some embodiments, a battery pack may power more than two electric engines. In some embodiments, a battery pack may power two or more sets of diagonally symmetric electric engines. In some embodiments, the set of electric engines powered by a battery pack may include an inboard diagonally symmetric pair of electric engines and an outboard diagonally symmetric pair of electric engines. In some embodiments, a battery pack may power four or more electric engines in a configuration that is symmetrical across the longitudinal axis of symmetry.

In some embodiments, some or all of the battery packs are interconnected. As described above, a cross-link may allow each battery pack to act as backup power for another. For example, in some embodiments, a first battery pack may directly power a first number of electric engines and a second battery pack may directly power a second number of electric engines. The first and second battery packs may be cross-linked together to form a battery pack unit. Therefore, each battery pack in the unit may act as a backup for the other. Upon failure of a battery pack in the unit, the failing battery pack may be disconnected, and electric engines will be powered by one or more non-failing battery packs in the unit. The battery packs in a battery pack unit may be electrically separate from other battery pack units.

In some embodiments, a battery pack unit may comprise three battery packs, wherein each battery pack powers a number of electric engines. For example, in some embodiments, each battery pack may power two diagonally symmetric electric engines. Therefore, each battery pack unit may power a total of six electric engines and each electric engine has two battery pack backups. In some embodiments, each battery pack in the battery pack unit may power four electric engines, comprising two sets of diagonally symmetric electric engines. Therefore, each battery pack unit may power a total of twelve electric engines and each electric engine has two battery pack backups.

In some embodiments, a battery pack unit may comprise four battery packs, wherein each battery pack powers a number of electric engines. For example, in some embodiments, each battery pack may power two diagonally symmetric electric engines. Therefore, each battery pack unit may power a total of eight electric engines and each electric engine has three battery pack backups. In other embodiments, each battery pack in the battery pack unit may power four electric engines, comprising two sets of diagonally symmetric electric engines. Therefore, each battery pack unit may power sixteen electric engines and each electric engine has three battery pack backups.

In some embodiments, all battery packs are cross linked to their neighbors, forming a circular power supply for the battery packs. In some embodiments, all battery packs are connected to a common bus. In some embodiments, the common bus may form a circular power supply, providing for additional redundancy in connections, while in other embodiments the common bus may not form a circular power supply.

In some embodiments, electric engines comprise a single motor that is powered by the one or more battery packs. In some embodiments, each electric engine may include two or more partial motors and the battery packs may power partial motors. In some embodiments, any of the electric engine powering configurations described above may include powering partial motor(s) of battery pack(s).

Different configurations of battery packs, electric engines, battery pack to electric engine connections, and battery pack cross link combinations may be chosen to best balance aircraft power needs, system redundancy, and fault tolerance. For example, different configurations may be used to accommodate the specifics of aircrafts shown in FIGS. 1C-1H, above.

FIG. 1K illustrates that the battery packs may also power a tilt propeller system of the electric propulsion units. For example, the battery packs may power linear and/or rotary actuators to change the orientation of a propulsion system (e.g., tilt angles of one or more tilt propellers) during operation (represented by T1-T6). In some embodiments, a rotary actuator may include a motor, inverter, and gearbox. In some embodiments, as shown, each battery pack powers a tilt propeller system that corresponds to an electric engine being powered by the battery pack. As described above, the aircraft may include a different number and/or combination of battery pack and propulsion system arrangements (with corresponding tilt propeller systems). In some embodiments, each of the arrangements described with reference to FIG. 1J may further include the battery pack configured to provide power to a tilt actuator in addition to the electric propulsion unit (e.g., electric engine) whose tilt is controlled.

FIG. 1L illustrates that the battery packs may also have power running to one or more DC/DC converters to supply low voltage power to the low voltage components of the aircraft. Further, one or more of the battery packs may power environmental conditioning equipment (e.g. a compressor, fan, or other equipment requiring high voltage power). In some embodiments the low voltage system is powered without a separate low voltage battery, while in other embodiments one or more low voltage components may be powered by a separate low voltage battery.

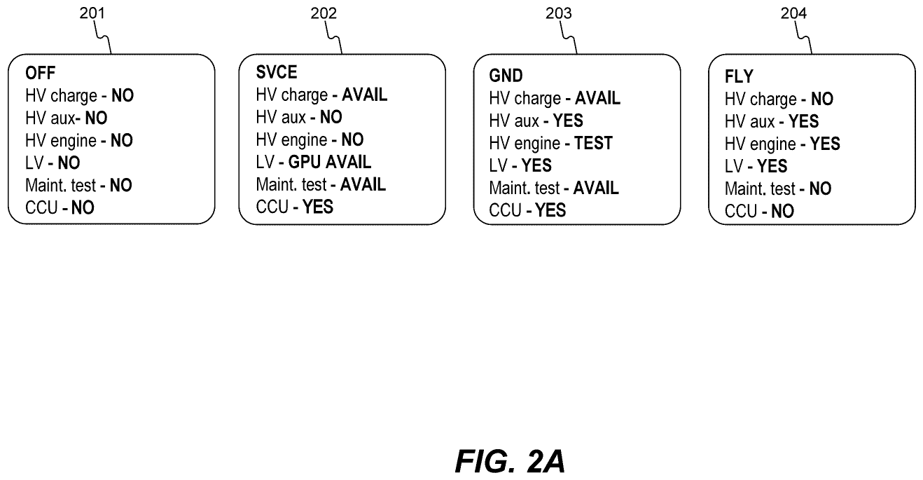

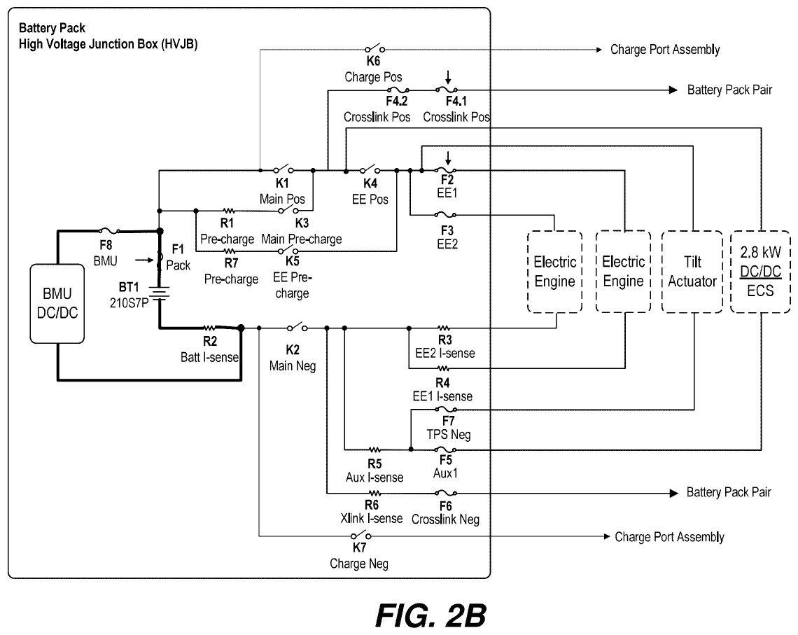

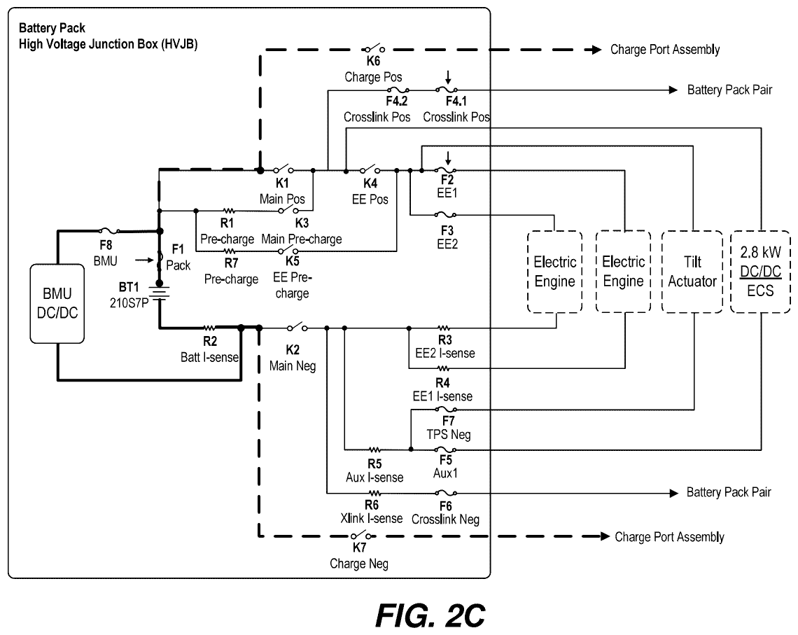

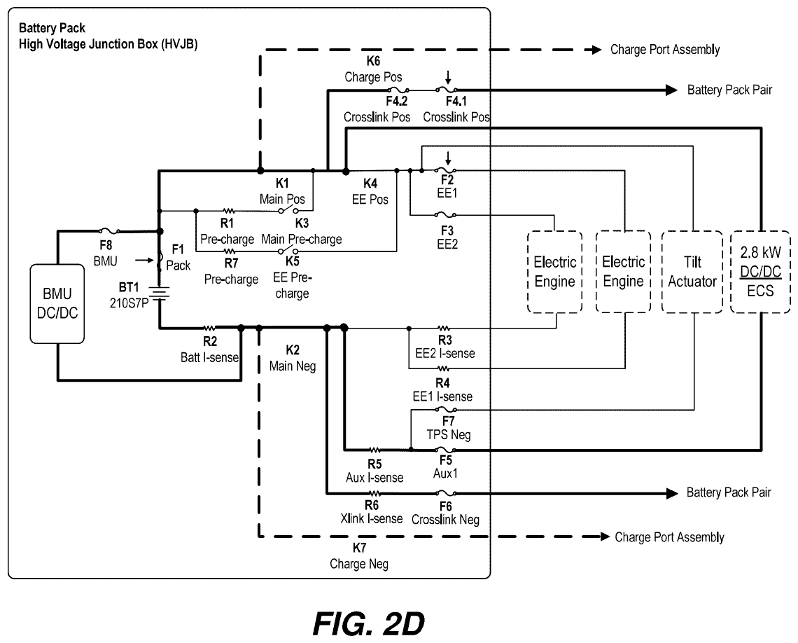

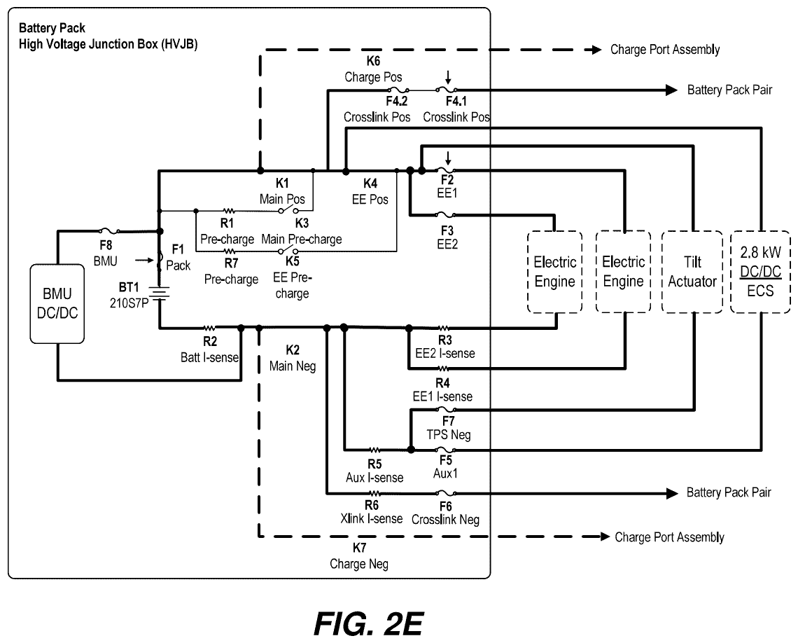

FIG. 2A illustrates modes of an aircraft, consistent with embodiments of the present disclosure. As discussed further herein, at least one aircraft component (e.g., at least one controller, at least one processor, at least at battery management unit, at least one mode switch, or any combination thereof), connected to one or more electrical systems of the aircraft, may control power distribution to one or more components and/or subsystems, consistent with disclosed embodiments. In some embodiments, a mode switch (or other component) may distribute power based on (e.g., in response to, limited by) a selected mode (e.g., selected by a user at an interface, such as a graphical user interface or a physical moving part, consistent with disclosed embodiments). Additionally, a mode switch may also distribute power based on a state among a plurality of possible states being present in a particular mode, consistent with disclosed embodiments.

In some embodiments, a mode switch may be configured to cause power to be distributed (e.g., flow or not flow) in different configurations (e.g., with each configuration being associated with a respective mode). In some embodiments, one selectable mode may be associated with connecting power (or maintaining a connection of power) to one set of components (e.g., at least one subsystem, at least one low-voltage subsystem, at least one high-voltage subsystem, at least one charging subsystem, at least one bus, or any combination thereof) while disconnecting (or maintaining a disconnection of power) to another set of components. In some embodiments, another selectable mode may be associated with connecting power to multiple subsystems (e.g., all systems needed for flight of an aircraft). In some embodiments, a mode switch may be configured to implement one or more of the modes described herein.

In Off Mode 201, Subsystem 101 is disabled and no high voltage power will run to the electric engines and tilt actuators. Subsystem 102 is disabled and no high voltage power will flow from the battery packs to the DC/DC converters to feed the low voltage distribution system. Subsystem 103 is disabled and no low voltage power will be distributed through the low voltage distribution system. Subsystem 104 is disabled and no charge will be applied to the battery packs. Subsystem 105 is disabled and the CCU will remain unpowered. In Off Mode 201, maintenance testing of the aircraft is not available.

In Service Mode 202, Subsystem 101 is disabled and no high voltage power will run to the electric engines and tilt actuators. Subsystem 102 is disabled and no high voltage power will flow from the battery packs to the DC/DC converters to feed the low voltage distribution system. Subsystem 103 is enabled but low voltage power may only be sourced through a ground power unit, not through Subsystem 102. Subsystem 104 is enabled and battery packs may be charged. Subsystem 105 is enabled and the CCU will be powered.

Further, in Service Mode 202, service mode maintenance is available when the low voltage distribution system (i.e. Subsystem 103) is powered through a ground unit. An aircraft component, such as a System Control Unit (SCU) used to control low voltage power distribution, may receive a signal indicating Service Mode 202 and may enable service mode maintenance. For example, the SCU and/or one or more other aircraft components, may enable software loading. In Service Mode 202, software may be loaded onto one or more battery management units. Further, the SCU and/or one or more other aircraft components, may enable testing of the low voltage equipment. Low voltage equipment testing may include testing the avionics, flight control computers, aircraft flight control surfaces, motors controllers, pitch actuators, tilt actuators, battery management systems for the battery packs, environmental control systems, sensors, and/or any other system on the aircraft requiring low voltage power.

In Ground Mode 203, Subsystem 101, including high voltage power to the electric engines and tilt actuators, is enabled when maintenance testing is performed. Subsystem 102 is enabled and power will flow from the battery packs to the DC/DC converters to feed the low voltage distribution system. Subsystem 103 is enabled and low voltage power will be distributed through the low voltage distribution system. Low voltage power may be sourced through the DC/DC converters (e.g. through Subsystem 102) or through one or more ground units. Subsystem 104 is enabled and the battery packs may be charged. Subsystem 105 is enabled and the CCU will be powered.

Further, in Ground Mode 203, ground mode maintenance is available. An aircraft component, such as a System Control Unit (SCU) used to control low voltage power distribution, may receive a signal indicating Ground Mode 203 and may enable ground mode maintenance. Ground mode maintenance may include software loading to different aircraft systems. In some embodiments, ground mode maintenance may prohibit software loading to the battery management units (BMUs). The SCU and/or one or more aircraft components may allow testing of the low voltage equipment. Low voltage equipment testing may include testing the avionics, flight control computers, aircraft flight control surfaces, motors controllers, pitch actuators, tilt actuators, battery management systems for the battery packs, environmental control systems, sensors, and/or any other system on the aircraft requiring low voltage power.

In some embodiments, maintenance mode may be selected through a user input device. For example, maintenance mode may be selected through a physical switch, button, lever, and/or display element. The user input device may be mounted on the body of the aircraft and/or in the pilot cockpit. In some embodiments, maintenance mode may be selected through the mode switch. As further described below, the selection of a maintenance mode may be communicated to the CCU.

Further, the FCS and/or other components may receive a signal indicating ground mode maintenance testing and may allow testing of high voltage equipment. The FCS and/or other components may facilitate testing of the electric engines and associated electric propulsion units, such as the rotors, proprotors, and/or propellers. The FCS and/or other components may facilitate testing of the tilt propeller system, including linear and/or rotary actuators.

In Fly Mode 204, Subsystem 101 is enabled and high voltage power will run to the electric engines and tilt actuators. Subsystem 102 is enabled and power will flow from the battery packs to the DC/DC converters to feed the low voltage distribution system. Subsystem 103 is enabled and low voltage power will be sourced through the DC/DC converters and associated battery packs. Subsystem 104 is disabled and no charge will be applied to the battery packs. Subsystem 105 CCU is disabled and the CCU will remain unpowered. In Fly Mode 204, maintenance testing of the aircraft is not available.

In some embodiments, the aircraft will be prohibited from flying in an off mode, service mode, and/or ground mode. For example, a flight control system may prevent the aircraft from being controlled in a manner that allows for takeoff.

While four modes are provided as an example, the aircraft may include a different number of modes. For example, an aircraft may include two modes including an off mode and fly mode or a service and fly mode. For example, an aircraft may include three modes including an off mode, a ground mode, and a fly mode. For example, an aircraft may include five modes, including a charging mode in addition to the modes shown in FIG. 2A. For example, an aircraft may include additional modes based on an intended type of flight. For example, one mode may provide high voltage power required for a conventional takeoff and landing mission, while another may provide power for a powered lift mission (e.g., including power to lifters). In some embodiments, when a different number of modes are employed, different conditions may need to be checked prior to allowing transition been the modes. For example, an aircraft with a service mode and fly mode may check the continuity of the DC/DC converters prior to allowing transition to fly mode. An aircraft with different modes depending on a type of flight may check the continuity of the electric propulsion units and/or tilt actuators being employed for that flight type.

As shown, based on the mode selection, power can be controlled to different subsystems. For example, in some embodiments, high voltage is controlled differently (e.g., different HV circuits are connected to a power source) in at least three modes of operation (e.g., off, ground, and fly). In some embodiments, low voltage is controlled differently (e.g., different LV circuits are connected to a power source) in at least two modes of operation (e.g., standby and ground). In some embodiments, low voltage is controlled in the same manner (e.g., substantially the same LV distribution lines are connected to a power source) in at least two modes of operation (e.g., ground and fly).

FIGS. 2B, 2C, 2D, and 2E illustrate power associated with modes of an aircraft, consistent with embodiments of the present disclosure. In some embodiments, the mode selection is communicated to a battery management unit (BMU) of each battery pack, which is configured to respond by opening and/or closing one or more switching devices. A BMU may include one or more computers, processors, microprocessors, controllers, and/or associated circuitry. One or more mode selections may be communicated to the BMU by a central charge control unit, flight control system, and/or a different component(s) of the aircraft. Further, in some embodiments, the BMU, FCS, and/or another component may confirm one or more conditions are met prior to switching into a selected mode. After confirmation, the BMU may control one or more switching devices to enable and/or disable certain subsystems. Switching device(s) K1-K7 may include contactor(s), relay(s), transistor(s), controller(s), and/or any other device capable of switching on and off electricity. In some embodiments, K1-K7 are all contactors. As detailed below, switching devices K2-K7 may control whether battery pack(s) receive a charge from Subsystem 104 including the charging bus. Switching devices K1-K5 may control whether high voltage power flows to the electric engines, tilt actuators, and/or DC/DC converters. Therefore, the switching devices may enable and/or disable Subsystem 101 including the high voltage power to electric engines and tilt actuators. Further, the contactors may enable and/or disable Subsystem 102 including the high voltage power to DC/DC converters for low voltage distribution.

Further, as shown, each battery pack may include a high voltage junction box (HVJB) which is electrically connected to the HV loads to provide high voltage power. Specifically, the power storage element BT1 (e.g., the battery cells connected in parallel and in series) can be used to provide the high voltage power. The power storage element BT1 is connected to each of the HV loads through pre-charge resistor(s) (e.g., resistor R1 and R7) or current sensing resistor(s) (e.g., resistors R2-R6), switching devices K1-K5 (e.g., HV contactors), and a combination of active and passive fuses (e.g., F1-F7) to protect against various failure conditions (e.g., overcurrent, short-circuit etc.). In some embodiments, a different configuration of active and passive fuses may protect against failure conditions. For example, a single active fuse may be included on the cross link between battery packs.

In FIG. 2B, showing an “off” mode, no high voltage power is provided to the aircraft components. The BMU may command switches K1-K7 open (e.g., active). Further, the BMU is powered by a BMU DC/DC converter, allowing it to periodically wake and monitor cells (V, T, I), estimate HV isolation, perform balancing, and/or detect latch faults. As further described below, FIG. 2B also shows a “service” mode, except that a CCU (not shown) is powered in the service mode through the internal DC/DC converter. FIG. 2C, illustrates that in a “service” mode, charging may be enabled.

In FIG. 2D, showing a “ground” mode, high voltage power is provided to the DC/DC converters and ECS system, allowing for powering of the low voltage system and environmental control equipment. The BMU may command switching device K3 closed (e.g., deactivated) to allow for pre-charging of the circuit and limit in rush current to DC/DC converters and ECS equipment circuitry. Once the BMU determines that pre-charging is complete (e.g., a set time has elapsed or voltage or stored charge has risen to a threshold level), the BMU will open K3 and close K1 and K2, allowing high voltage power from the battery pack to feed the DC/DC converter and/or ECS equipment. In some embodiments, by closing K1 and K2, power is also supplied to a cross-link (e.g., cross-link 130) to one or more connected battery packs, thereby providing a backup power supply. Further, the BMU may estimate a high voltage isolation, publish pack status to the FCS, and/or detect and react to faults in the circuitry.

FIGS. 2C and 2D detail how an exemplary arrangement of circuitry and switches provides for flexibility in charging by allowing for auxiliary loads and/or electric engines and actuators to be energized or de-energized in the charging process. For example, as shown in FIG. 2C, in one switch open/closed arrangement, the battery pack may be charged while the remaining HVPS circuitry remains disconnected. Charging switching devices K6 positive and K7 negative may be closed to allow the battery pack to charge. Meanwhile, main switching devices K1 and K2 and pre-charge switching devices K3 and K5 may be open to prevent energizing the remaining HVPS circuitry. Further, as shown in FIG. 2D, in one switch open/closed arrangement, the battery pack may be charged while the auxiliary loads are connected but electric engines and actuators remain disconnected. Charging switching devices K6 positive and K7 negative may be closed to allow the battery pack 120 to charge. Further, main switching devices K1 and K2 may remain closed (after pre-charge) and K4 may remain open. In some embodiments, the BMU may coordinate with a charge control unit (detailed below) to open and close charging switching devices (e.g. K6 positive and/or K7 negative) based on the detected charge level of the battery pack and a desired charge level.

In FIG. 2E, showing a “fly” mode, high voltage power is provided to the electric engines and/or tilt actuators. The BMU may command switching device K5 closed, allowing for pre-charging of the electric engines and/or tilt actuators. In some embodiments, once the BMU determines that pre-charging is complete (e.g., a set time has elapsed or voltage or stored charge has risen to a threshold level), the BMU may open K5 and close K4, allowing high voltage power to feed the electric engines and/or tilt actuators. Further, the BMU may manage the main bus (e. g detect measurements and react accordingly), estimate HV isolation, and detect faults. In some embodiments, certain fault reactions are inhibited in fly mode. For example, even if a fault is detected (e.g. isolation monitor detects current to ground), switching device(s) will remain close and power will remain connected.

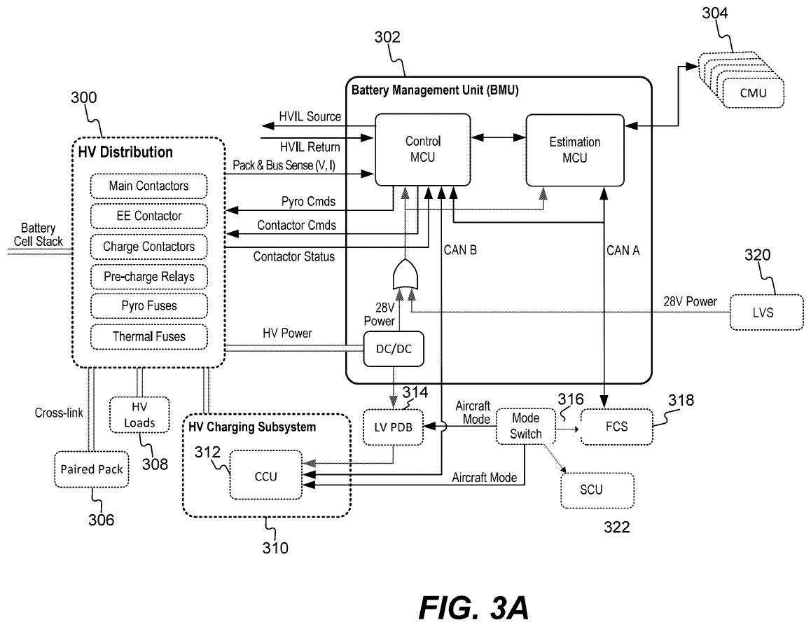

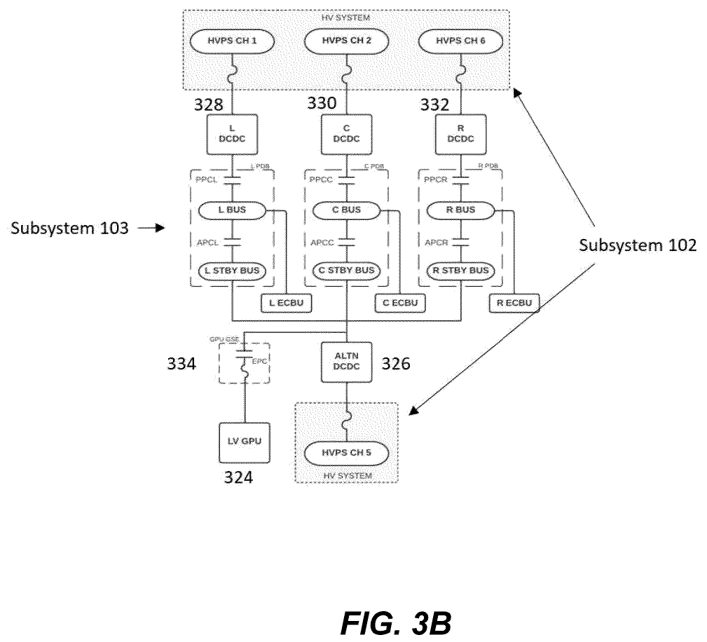

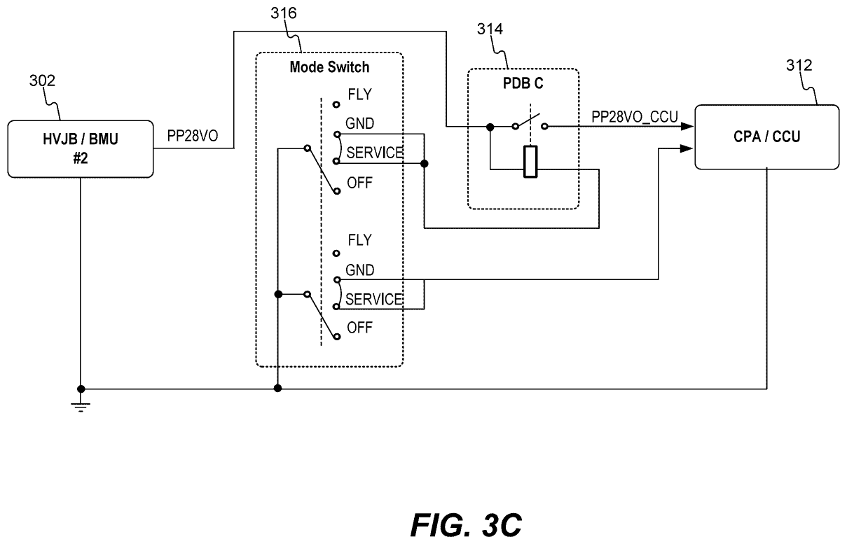

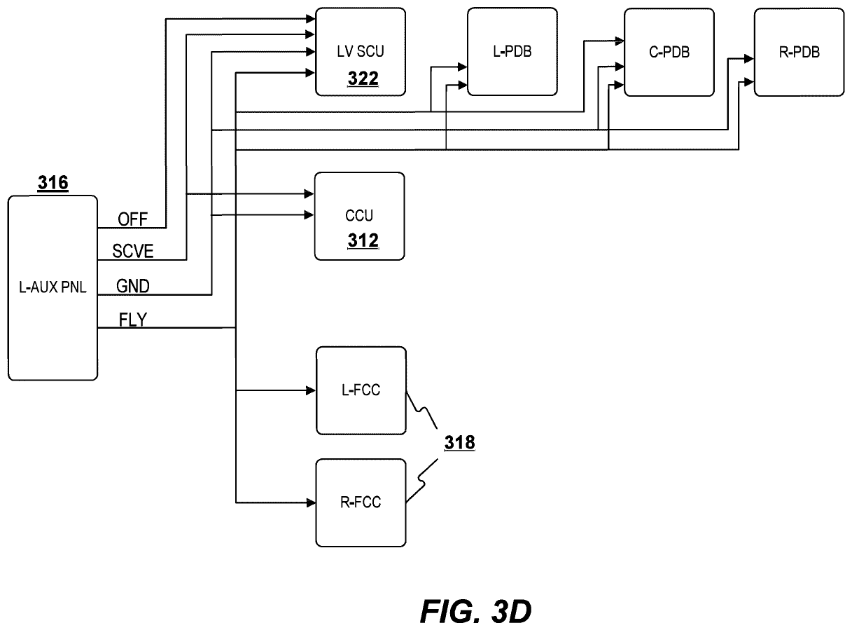

FIG. 3A illustrates a diagram of aircraft circuity, consistent with embodiments of the present disclosure. A person (e.g., pilot, technician) may select a desired mode through the mode switch 316. In some embodiments, the mode switch 316 is located on a pilot dashboard and/or panel. In some embodiments, the mode switch 316 may be a device remote from the aircraft. For example, the mode switch 316 may include a transmitter to send a mode selection to the aircraft via a wireless link (e.g., radio link). In some embodiments, mode switch 316 may be a physical switch, knob, button, lever, and/or any mechanical part configured to be moved by a user. In some embodiments, the mode switch 316 requires a force to unlock the lever before changing modes to avoid accidental mode changes. In some embodiments, mode switch 316 may be a user interface element provided on a pilot's display screen or control panel. In some embodiments, mode switch 316 may be a processor that may receive a pilot's manual selection and/or voice command requesting a mode switch. The mode switch 316 may include any means that allows the pilot to select a desired mode of operation. In some embodiments, the mode switch 316 and/or an associated panel (e.g. controller(s), processor(s) etc.) for the mode switch 316 may include physical restraints or logic that provide limits on the mode transition. For example, in some embodiments, the mode switch 316 may include one or more of the following limits: only allow transitions from Off Mode 201 to Service Mode 202, Service Mode 202 to Ground Mode 203, Ground Mode 203 to Fly Mode 204, Fly Mode 204 to Ground Mode 203, Ground Mode 203 to Service Mode 202, and Service Mode 202 to Off Mode 201.

In some embodiments, the selected mode is communicated to a switching device in a LV power distribution box 314 (LV PDB). In some embodiments, the switching device is separate from the LV PDB 314. The switching device may a relay (e.g., single pole single throw relay), transistor, contractor, controller, or any other device capable of switching power on and off. The switching device may allow power to flow from the battery pack to the CCU 312 in Service Mode 202 and Ground Mode 203. In some embodiments, the selected mode is communicated to a System Control Unit (SCU) 322 used to control low voltage power distribution. For example, in some embodiments, the selected mode may be communicated to the SCU 322 to control low voltage distribution in Fly Mode 204, in Ground Mode 203, and/or in Service Mode 202 when a ground unit is providing low voltage power. In some embodiments, the selected mode may also be communicated to the FCS 318. In some embodiments, the mode selection is communicated to the FCS 318 directly from the mode switch 316. For example, in some embodiments, when the selected mode is Fly Mode 204 the mode switch 316 sends the selected mode to the FCS 318 and/or one or more flight control computers. In some embodiments, the mode and/or state selection is communicated to the FCS 318 through the CCU 312 and/or other components. For example, in some embodiments, the CCU 312 and/or other components may communicate the mode and/or state when the aircraft is in Ground Mode 203, low voltage is provided by a ground unit, and/or the aircraft is in a maintenance state. In other embodiments, the mode switch 216 sends a signal directly to the FCS 318 in all aircraft modes and/or states.

As detailed above with reference to FIGS. 2B-2E, high voltage distribution 300 may include a combination of switching devices and/or fuses. For example, high voltage distribution 300 may include main contactors, electric engine contactors, charge contactors, pre-charge relays, pyro-fuses, and thermal fuses. Further, as shown, high voltage distribution 300 may power a variety of HV loads 308 (e.g., electric engines, low voltage systems, equipment) and may provide power to one or more paired battery packs 306 (e.g., through a cross-link 130 shown above in FIGS. 1J-1L).

Battery Management Unit (BMU) 302 may monitor the conditions of one or more battery packs and may communicate with various systems within and outside the battery pack. For example, the BMU 302 may receive voltage, current, resistance, and temperature sensing signals from the cell stack assembly (and CMUs 304) and/or HV Distribution 300. In some embodiments, the BMU 302 performs computation of the state of charge (SOC), state of health (SOH), failure condition (e.g. short circuit or overcurrent), state of power (SOP), state of energy (SOE) and state of temperature (SOT) of the battery pack. The BMU 302 also controls and monitors bus pre-charging, provides fuse and contactor commands, and communicates with various systems within and outside the battery pack. In some embodiments, the BMU 302 may communicate with the Flight Control System 318. In some embodiments, the BMU 302 may receive power from the Low Voltage System 320, included in Subsystem 103. In some embodiments, BMU 302 may receive power from one or more battery pack cell stacks (e.g., as shown above with reference to FIGS. 2B-2E).

In some embodiments, one or more high voltage battery packs may power the charge control unit (CCU) 312. In some embodiments, only one high voltage battery pack may power the CCU 312. In some embodiments, the CCU 312 may have dedicated high voltage circuitry and a DC/DC converter, separate from the high voltage circuitry in Subsystem 102 and Subsystem 101. In some embodiments, power may be available for the LV PDB 314, regardless of the aircraft mode. In these embodiments, for example, the CCU 312 may be enabled in Ground Mode 203 and Service Mode 202, even when Subsystem 102, including high voltage to converters for low voltage distribution, and Subsystem 103, including the low voltage distribution system, are disabled. As described above, in some embodiments, instead of CCU 312 a separate controller (e.g., a central battery management unit and/or battery management system) may be powered through the switching device in LV PDB 314 and receive the selected mode. In some embodiments, the separate controller may include multiple controllers for redundancy. The controller(s) may include one or more power connections through switching devices. The controller(s) may perform the communication with and/or control of different components of the aircraft. In some embodiments, the controller(s) perform any of the functions disclosed as being performed by the CCU and/or BMU.

FIG. 3B illustrates another diagram of aircraft circuity, consistent with embodiments of the present disclosure. As shown, Subsystem 102 provides high voltage power to one or more DC/DC converters (e.g. 328, 330, 332, 326) to feed Subsystem 103, including low voltage distribution circuitry and/or components. In some embodiments, one or more of the DC/DC converters may be an alternate DC/DC converter (e.g. 326) which allows for power-up of the aircraft and/or acts as a backup to the other DC/DC converters. In some embodiments, in Ground Mode 203, the one or more alternate DC/DC converter(s) may feed Subsystem 103, including low voltage distribution circuitry and/or components.

Further, the aircraft may include a low voltage port assembly 334 allowing for connection between Subsystem 103 and a low voltage ground power unit (LV GPU 324). In some embodiments, low voltage port assembly 334 may include one or more switching devices (e.g. relay, contactors, transistors etc.) that allow for connection of the low voltage power to Subsystem 103, including low voltage distribution circuitry and/or components. In some embodiments, low voltage port assembly 334 may communicate with one or more components (e.g. SCU 332, CCU 312 etc.) upon connection of low voltage power from LV GPU 324. In some embodiments, the LV GPU 324 may be connected in Service Mode 202 to allow for maintenance of the aircraft (e.g. testing, software loading etc.).

FIG. 3C illustrates a diagram of the mode switch 316, consistent with embodiments of the present disclosure. As described above, the selected mode is communicated to a switching device (e.g. a relay and/or a transistor) in Power Distribution Box 314 and CCU 312. In Ground Mode 203 and Service Mode 202, the switching device in Power Distribution Box 314 is closed. Once the switching device is closed, power may flow from the battery pack and DC/DC converter, powering the CCU 312. Once powered, the CCU 312 receives the selected mode, Ground Mode 203 or Service Mode 202, and communicates with the Battery Management Units 302 according to the selected mode. As described above, in some embodiments, instead of CCU 312 a separate controller (e.g., a central battery management unit and/or battery management system) may be powered through the switching device in LV PDB 314 and receive the selected mode.

FIG. 3D illustrates another diagram of a mode switch 316, consistent with embodiments of the present disclosure. As described above with reference to FIG. 3A, in difference modes, different subsystems may be enabled and/or disabled. FIG. 3A schematically illustrates some of the different components that may be communicated with and/or controlled in certain modes. In some embodiments, one or more of these subsystems may be directly enabled and/or disabled by the mode switch 316. In some embodiments, one or more of these subsystems may be enabled and/or disabled by the mode switch 316 communicating with one or more other components. When Off Mode 201 is selected on mode switch 316, the mode switch 316 may communicate with and/or control LV SCU 322 (e.g. directly or through other components) to disabled subsystems as described above with reference to FIG. 2A. When Service Mode 202 is selected on mode switch 316, the mode switch 316 may communicate with and/or control LV SCU 322 and/or CCU 312 (e.g. directly or through other components) to enable and/or disabled subsystems as described above with reference to FIG. 2A. When Ground Mode 203 is selected on mode switch 316, the mode switch 316 may communicate with and/or control LV SCU 322, CCU 312, and/or power distribution box(es) (e.g. directly or through other components) to enable and/or disabled subsystems as described above with reference to FIG. 2A. When Fly Mode 204 is selected on mode switch 316, the mode switch 316 may communicate with and/or control LV SCU 322, FCS 318 and/or power distribution box(es) (e.g. directly or through other components) to enable and/or disabled subsystems as described above with reference to FIG. 2A. As described above, in some embodiments, instead of CCU 312, a separate controller (e.g., a central battery management unit and/or battery management system) may receive the selected mode.

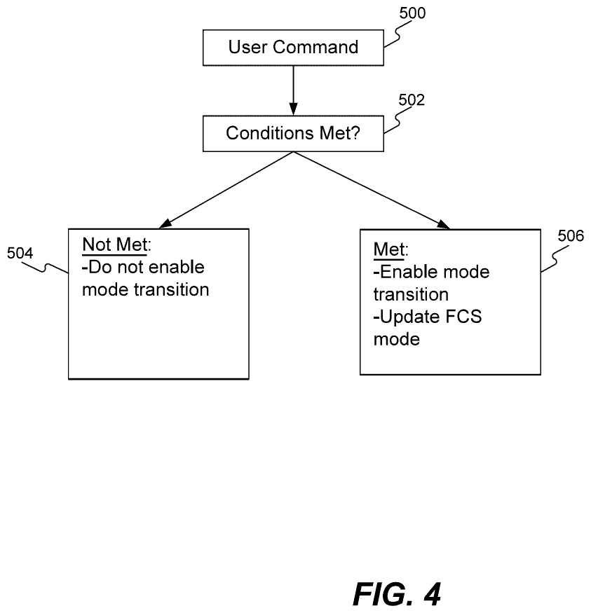

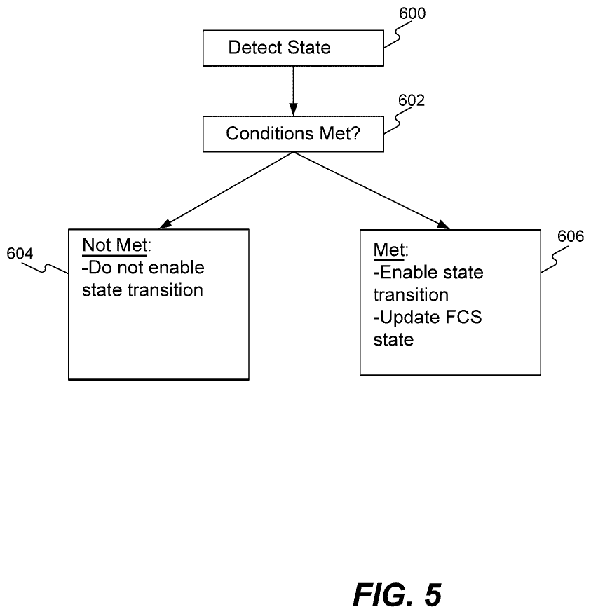

FIG. 4 illustrates a flow chart for switching aircraft modes, consistent with embodiments of the present disclosure. As detailed in the flow chart, in some mode transitions, certain conditions must be met prior to controlling subsystems to transition to the new selected mode. However, in some mode transitions, no preconditions must be met prior to the transition. In some embodiments, the FCS 318 stores the computed mode that the aircraft is transitioned to, while in other embodiments it does not. At Step 500, CCU 312 and/or FCS 318 may detect a selection (e.g., by a user at an interface) of an aircraft mode on mode switch 316. The aircraft mode may include: Off Mode 201, Service Mode 202, Ground Mode 203, and Fly Mode 204. At Step 502, if applicable, a device may check whether conditions are met to transition the aircraft to the selected mode. At Step 504, if the conditions are not met, then the transition will be prohibited and the subsystems will stay in their current condition. At Step 506, if the conditions are met (or if no conditions are required for the transition), the subsystems will be controlled according to the selected mode. For example, Subsystem 101, Subsystem 102, Subsystem 103, Subsystem 104, and/or Subsystem 105 may be enabled or disabled based on the mode, as shown above with reference to FIG. 2A. In some embodiments, the steps outlined FIG. 5 may be performed by the CCU 312 and/or the FCS 318. In some embodiments, the component performing the steps may vary based on which modes the aircraft is transitioning between. In some embodiments, the FCS 318 may update the computed mode. Below are descriptions of example mode transitions, consistent with embodiments of the present disclosure.

### Off Mode 201 to Service Mode 202

At Step 500, a device (e.g., CCU 312) may detect a selection (e.g., by a user at an interface) of a change from Off Mode 201 to Service Mode 202 on the Mode Switch 316. In some embodiments, there are no preconditions to enabling this transition. At Step 506 the Subsystem 105 is enabled. The CCU 312 is powered and has received a signal that Service Mode 202 is selected.

### Service Mode 202 to Ground Mode 203

At Step 500, a device (e.g., CCU 312) may detect a selection (e.g., by a user at an interface) of a change from Service Mode 202 to Ground Mode 203 on the Mode Switch 316. The CCU 312 may be powered (and/or remain powered) and receive a signal that Ground Mode 203 is selected. In some embodiments, the CCU 312 may communicate the selected mode to one or more Battery Management Units 302 and/or to the flight control system (FCS) 318. At Step 502, the BMU(s) 302 may determine whether the HVIL continuity status is met for the relevant loads. For example, the BMU(s) 302 may determine the HVIL continuity status is met when a DC/DC converter is connected on both sides and/or other auxiliary loads (e.g. heater, compressor, and/or other thermal conditioning components) are appropriately connected. Further, the BMU 302 and/or CCU 312 may control the pre-charge of the battery pack(s) and may confirm the pre-charge is complete (e.g., a set time has elapsed or voltage or stored charge has risen to a threshold level) prior to enabling transition to Ground Mode 203. The BMUs 302 may not allow the transition to Ground Mode 203, if one or more of the conditions are not met. At Step 504, if the conditions are not met, the aircraft may not be transitioned to Ground Mode 203. At Step 506, if the continuity conditions are met, the aircraft may be transitioned to Ground Mode 203. Subsystem 102, including high voltage to DC/DC converters for low voltage distribution, may be enabled. Subsystem 103, including the low voltage distribution system, may also be enabled. In some embodiments, in Ground Mode 203, the low voltage power will be from an alternate DC/DC converter.

In some embodiments, transitioning to Ground Mode 203 may include powering SCU 322 which then receives a signal from mode switch 216 and/or another component (e.g. CCU 312) indicating Ground Mode 203 is selected. In some embodiments, transitioning to Ground Mode 203 may include a system control unit (SCU) 322 commanding one or more low voltage power distribution boxes (LV PDB) to enable power to one or more low voltage systems. For example, in some embodiments, the SCU 322 may command three power distribution boxes, connected to three low voltage buses, to allow distribution of low voltage power. In some embodiments, the FCS 318 may change its computed mode to ground mode. In some embodiments after transitioning to Ground Mode 203 and/or changing the computed mode to Ground Mode 203, the FCS 318 will take over control of the aircraft (e. g from the CCU 312). The FCS 318 will issue specific commands to each subsystem based on user input, sensor input, flight conditions etc.

### Ground Mode 203 to Fly Mode 204

At Step 500, a device (e.g., FCS 318) may detect a selection (e.g., by a user at an interface) of a change from Ground Mode 203 to Fly Mode 204. In some embodiments, the selection of fly mode may be communicated to the System Control Unit (SCU) 322, one or more LV power distribution boxes (LV PDB), and the Flight Control System 318. The CCU 312 will not be powered. In some embodiments, the CCU 312 will be de-energized based on the switching device in LV PDB 314 disconnecting the CCU 312 from power. At Step 502, one or more conditions may be checked. In some embodiments, the FCS 318 and/or other device(s) may check the battery pack temperature to confirm it is within an allowable range for flying. In some embodiments, the allowable range may be a temperature range that allows the aircraft to safely perform the next mission. In some embodiments, the FCS 318 and/or other device(s) may confirm that no charger is connected to the aircraft. In some embodiments, the FCS 318 and/or other device(s) may confirm that no coolant lines are connected to the aircraft. In some embodiments, the FCS 318 and/or other device(s) may confirm that no other plug used to power the low voltage distribution system is connected to the aircraft. In some embodiments, the BMU 302 and/or other device(s) may check the HVIL continuity status of the electric engines and tilt actuators. In some embodiments, BMU 302 may provide continuity status information to the FCS 318. At Step 504, if any of the one or more conditions are not met, the transition to Fly Mode 204 will be prohibited. In some embodiments, the computed mode for the FCS 318 will remain Ground Mode 203. At Step 506, if all the one or more conditions are met, the transition to Fly Mode 204 will be allowed. Subsystem 101 will be enabled, providing high voltage power to the electric engines and tilt actuators. In some embodiments, in Fly Mode 204, Subsystem 103, including the low voltage distribution, will be fed from the main DC/DC converters and the alternate DC/DC converter will act as a backup. In some embodiments, the FCS 318 will store the computed mode as Fly Mode 204. In some embodiments, the FCS 318 may communicate to one or more aircraft subsystems indicating that the mode is Fly Mode 204.

### Fly Mode 204 to Ground Mode 203

At Step 500, a device (e.g., CCU 312) may detect a selection (e.g., by a user at an interface) of a change from Fly Mode 204 to Ground Mode 203. The signal may be sent to a LV PDB 314 and the CCU 312 may be powered, as described above. In some embodiments, the mode selection may be communicated to the System Control Unit (SCU) 322 and/or the Flight Control System 318. At Step 502, the FCS 318 and/or other device(s) may confirm that the aircraft is on the ground. In some embodiments, this may involve detecting from one or more sensors associated with landing gear that the landing gear is deployed and/or the aircraft is on the ground (e.g. a shock absorber sensor that monitors deflection). Additionally or alternatively, the FCS 318 and/or other device(s) may confirm that the aircraft is stationary (e.g. through GPS sensor, laser speed sensor, wheel speed sensor, gear tooth sensor etc.). Additionally or alternatively, the aircraft may be confirmed as stationary when the velocity is below a set threshold or when the velocity is zero. Additionally or alternatively, the FCS 318 and/or other device(s) may determine if the aircraft is on the ground by determining if an altitude of the aircraft is below a threshold (e.g., using an altimeter). At Step 504, if any of the one or more conditions are not met, the transition to Ground Mode 203 will be prohibited. At Step 506, if all the one or more conditions are met, the transition to Ground Mode 203 will be allowed. Subsystem 101 may be disabled and power to the electric engines and the tilt actuators will be removed. In some embodiments, the FCS 318 will store the computed mode as Ground Mode 203.

### Ground Mode 203 to Service Mode 202

At Step 500, a device (e.g., CCU 312) may detect a selection (e.g., by a user at an interface) of a change from Ground Mode 203 to Service Mode 202. The signal may be sent to a LV PDB 314 and the Charge Control Unit 312 may be powered, as described above. In some embodiments, there are no preconditions to enable this transition. At Step 506, Subsystem 103 will be disabled and low voltage power distribution fed from the battery packs will be removed. Further, Subsystem 102 may be disabled and high voltage power to the DC/DC converters will be removed. In some embodiments, the FCS 318 will store the computed mode as Service Mode 202.

### Service Mode 202 to Off Mode 201

At Step 500, a device (e.g., SCU 322) may detect a selection (e.g., by a user at an interface) of a change from Service Mode 202 to Off Mode 201. In some embodiments, there are no preconditions to enable this transition. At Step 406, Subsystem 105, including power to the CCU 312, will be disabled.

FIG. 5 illustrates exemplary transitions between states within a mode, consistent with embodiments of the present disclosure. As detailed in the flowchart, in some state transitions, CCU 312 and/or FCS 318 may not control subsystems in a new state unless certain conditions are met. However, in some state transitions, no preconditions must be met prior to the transition. In some embodiments, the steps FIG. 6 may be performed by the CCU 312 and/or the FCS 318. In some embodiments, the component performing the steps may vary based on which states the aircraft is transitioning between. At Step 600, the aircraft may detect an event, such as a user selection and/or a power source being connected. In some embodiments, the states of an aircraft may include a ground unit charging state, a low voltage supply from ground unit state, and/or a maintenance state. At Step 602, if applicable, a device may check whether conditions are met to transition the aircraft to the new state. At Step 604, if the conditions are not met, then the transition will be prohibited and the subsystems will stay in their current condition. At Step 606, if the conditions are met (or if no conditions are required for the transition), the subsystems will be controlled according to the new state. For example, Subsystem 101, Subsystem 102, Subsystem 103, Subsystem 104, and/or Subsystem 105 may be enabled or disabled based on the selected state. In some embodiments, FCS 318 may store the new state.

### Transition to Charging State

At Step 600, in Service Mode 202 and Ground Mode 203, the CCU 312 may detect that a charger (e.g., a power source) is connected to an associated charging port on the aircraft. At Step 602, the CCU 312 may communicate with battery packs (e.g. through BMUs 302) to detect voltage and/or current in the battery packs and confirm whether they are within predetermined limits to allow for charging. At Step 604, if the battery pack voltage and/or current conditions are not met, the CCU 312 may communicate the details of a problem (e.g. type of problem, such as insufficient current or voltage, relevant battery pack(s) etc.) to the ground charging equipment. The ground charging equipment may communicate the problem through a display, computer, laptop, iPad, mobile device, or any other device capable of communicating the information to a charging attendant.

At Step 606, if all the one or more conditions are met, the CCU 312 and/or Charging Subsystem 310 may engage a latch that prevents disconnection of the high voltage power plug. The CCU 312 may enable Subsystem 104, including the charging bus and associated devices. For example, CCU 312 may control switching devices to allow power flow between the ground charging equipment and the battery packs. Further, the CCU 312 and/or Charging Subsystem 310 may send a request for power to the ground charging equipment. In some embodiments, the flight control system (FCS) 318 may update its current state to charging.

### Low Voltage from Ground Unit State

At Step 600, in Service Mode 202 and Ground Mode 203, a Low Voltage CPU and/or other device(s) may detect that a ground unit is connected. In some embodiments, the ground unit may supply high voltage power that is stepped down from a DC/DC converter, such as an alternate DC/DC converter. In other embodiments, the ground unit may directly provide low voltage power. At Step 602, the Low Voltage CPU and/or other device(s) may confirm whether the power quality meets the aircraft's requirements. At Step 604, if the power quality conditions are not met, the aircraft will not be transitioned to allow low voltage power from the ground unit. At Step 606, if the power quality conditions are met, the aircraft will be transitioned to allow low voltage power from the ground unit. In some embodiments, a System Control Unit (SCU) 322 may command one or more low voltage power distribution boxes to enable power to one or more low voltage components. For example, in some embodiments, the SCU 322 may command three power distribution boxes connected to three low voltage buses to allow the low voltage power to feed various low voltage components. In some embodiments, the flight control system (FCS) 318 may update its current state to indicate low voltage power being provided by the ground unit.

### Maintenance State in Service Mode 202

At Step 600, in Service Mode 202, CCU 312 and/or FCS 318 may detect a selection of a maintenance state to perform testing or software uploads on the aircraft. In some embodiments, this selection may be made with mode switch 316, while in other embodiments it may be made with a separate user input device. In some embodiments the user input device may include a lever that requires a force to unlock the lever before changing to maintenance state to prevent accidental selection. In some embodiments, the maintenance switch may be a user interface element provided on a display screen or control panel to the pilot. In some embodiments, the maintenance switch may be a processor that receives a pilot's manual selection and/or voice command requesting maintenance state.

At Step 602, if the maintenance state is selected (e.g., as detected by CCU 312), the CCU 312 may communicate the selection to the flight control system 318. In some embodiments, this communication may be made through one or more battery management units 302. In some embodiments, the CCU 312 may communicate directly with the FCS 318. In some embodiments, there are no preconditions to enable the transition to service mode maintenance state. At Step 606, the FCS 318 may allow maintenance of the aircraft in service mode 202. For example, the FCS 318 may control various subsystems to allow for software loading, including the loading of software for the battery management units 302 (e.g., operations that FCS 318 may not allow in other modes). Further, the FCS 318 may control various subsystems to allow for testing of the low voltage equipment. For example, the FCS 318 may control testing of one or more flight control computers, aircraft flight control surfaces, motors controllers, pitch actuators, tilt actuators, battery management systems for the battery packs, environmental control systems, sensors, and/or any other low voltage system on the aircraft. The FCS 318 may store service mode maintenance state as the current state.

Maintenance State in Ground Mode 203: At Step 600, in Ground Mode 203, CCU 312 and/or FCS 318 may detect a selection (e.g., by a user at an interface) of a maintenance state to perform testing or software uploads on the aircraft. In some embodiments, this selection may be made with mode switch 316. As described above, in some embodiments, this selection is through a separate device. For example, through a lever that requires a force to unlock the lever before changing to maintenance state to prevent accidental selection. In some embodiments, the maintenance switch may be a user interface element provided on a display screen or control panel to the pilot. In some embodiments, the maintenance switch may be a processor that receives a pilot's manual selection and/or voice command requesting maintenance state.

At Step 602, the CCU 312 may communicate the selection to the flight control system 318. In some embodiments, this communication may be made through one or more BMUs 302. In some embodiments, the CCU 312 may communicate directly with the FCS 318. BMUs 302 may determine whether the HVIL continuity status is met, indicating the battery pack is connected on both ends (e.g. both sides of a DC/DC converter), prior allowing the transition to ground mode maintenance state and/or prior to allowing testing of the high voltage equipment. At Step 604, if one or more conditions are not met, ground mode maintenance and/or testing may be prohibited. At Step 606, if all the one or more conditions are met, the FCS 318 may allow ground mode maintenance. For example, the FCS 318 may control various subsystems to allow for software loading (e.g., an operation that FCS 318 may not allow in other modes). Further, the FCS 318 may control various subsystems to allow for testing of the low voltage equipment (e.g., an operation that FCS 318 may not allow in other modes). For example, the FCS 318 may control one or more flight control computers, aircraft flight control surfaces, motors controllers, pitch actuators, tilt actuators, battery management systems for the battery packs, environmental control systems, sensors, and/or any other system on the aircraft requiring low voltage power to be tested.

Further, in ground mode 203, the FCS 318 may allow testing of the high voltage equipment. For example, the FCS 318 may control subsystems to allow for testing of the electric engines, associated electric propulsion units, such as the rotors, proprotors, and/or propellers, and testing of the tilt propeller system, including linear and/or rotary actuators. In some embodiments, the FCS 318 may store maintenance state as the current state.

As discussed above, in some embodiments, prior to switching a mode or state of the aircraft, a continuity check may be performed. The continuity check may be performed to ensure the relevant circuit is complete and there are no open circuits (e.g., breaks or gaps in circuitry). In some embodiments, a continuity check may involve placing a small voltage across the relevant circuit and monitoring whether current flows through the circuit. If current flow is detected or meets an expected value, continuity is confirmed. If current flow is not detected or does not meet an expected value, the continuity is not confirmed. As described above, if the continuity is not confirmed, the aircraft may be prevented from transitioning to the next mode or state. In some embodiments, if continuity is not confirmed, an alert may be provided indicating a transition to the next mode or state may not be performed. In some embodiments, the alert may indicate the component and/or circuit where continuity could not be confirmed. In some embodiments, the alert may include displaying an image and/or text on a screen, turning on a light, or activating a sound.

In some embodiments, instead of and/or in addition to placing a small voltage across the relevant circuit to check its continuity, a voltage provided to a component and a voltage measured at the component may be compared. If a voltage is detected at the component and/or meets an expected value, the continuity of the relevant circuit is confirmed. If a voltage is not detected at the component and/or does not meet an expected value, the continuity of the relevant circuit is not confirmed. As described above, if the circuit continuity is not confirmed, the aircraft may be prevented from transitioning to the next mode or state and an alert may be provided. In some embodiments, a continuity check for a DC/DC converter includes placing a small voltage across the DC/DC converter to check its continuity. In some embodiments, a continuity check for electric engines and/or tilt actuators includes determining whether a received voltage is detected or meets an expected value when a power source provides a voltage. The continuity checks may be performed by a battery management system of the battery pack. The results of the continuity check may be communicated to a charge control unit and/or flight control system, depending on which component is performing the mode or state switch verification.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the inventions disclosed herein.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent to those skilled in the art from consideration of the specification and practice of the implementations disclosed herein. It is intended that the architectures and circuit arrangements shown in figures are only for illustrative purposes and are not intended to be limited to the specific arrangements and circuit arrangements as described and shown in the figures. It is also intended that the specification and examples be considered as exemplary only, with the true scope and spirit of the invention being indicated by the following claims. The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the inventions disclosed herein.

Additional aspects of the present disclosure may be further described via the following clauses:
1. A computer-implemented method of controlling aircraft power distribution, comprising:
   receiving, at a control circuit in an aircraft, a selection of one of at least three aircraft modes of operation from a user input device; and
   controlling, via the control circuit, power distribution within the aircraft based on the selected mode of operation, wherein controlling power distribution based on the selected mode of operation comprises:
      separately controlling via the control circuit, based on the selected mode of operation, high voltage power to at least one electric propulsion unit and high voltage power to at least one non-propulsion load.
2. The computer-implemented method of clause 1, wherein the user input device is at least one of: a switch, a knob, a button, a lever, a display screen element, or a voice receiver.
3. The computer-implemented method of clause 1 or 2, wherein controlling the power distribution within the aircraft comprises controlling at least one switching device.
4. The computer-implemented method of clause 3, wherein the switching device is at least one of a contactor, relay, or transistor.
5. The computer-implemented method of any of clauses 1-3, wherein in one of the at least three aircraft modes, controlling the power distribution within the aircraft comprises providing no high voltage power to the at least one electric propulsion unit and no high voltage power to the at least one non-propulsion load.
6. The computer-implemented method of any of clauses 1-5, wherein:
   controlling the power distribution within the aircraft based on the selected mode of operation further comprises controlling power to a controller,
   wherein the controller is configured to control the high voltage power; and
   wherein in one of the at least three aircraft modes, controlling the power distribution within the aircraft comprises powering the controller.
7. The computer-implemented method of any of clauses 1-6, wherein in one of the at least three aircraft modes, controlling the power distribution within the aircraft comprises providing no high voltage power to the at least one electric propulsion unit and providing high voltage power to the at least one non-propulsion load.
8. The computer-implemented method of clause 7, further comprising:
   determining whether one or more conditions are met upon receiving the selection of the one selected mode and prior to controlling the power distribution within the aircraft,
   wherein the one or more conditions being met includes at least one of: a pre-charge requirement being met or a continuity requirement being met.
9. The computer-implemented method of any of clauses 1-8, wherein in one of the at least three aircraft modes, controlling the power distribution within the aircraft comprises providing high voltage power to the at least one electric propulsion unit and high voltage power to the at least one non-propulsion load.
10. The computer-implemented method of clause 9, further comprising:
   determining whether one or more conditions are met upon receiving the selection of the one selected mode and prior to controlling the power distribution within the aircraft,
   wherein the one or more conditions being met includes at least one of: a continuity requirement is met for the at least one electric propulsion unit, a pre-charge requirement is met, a battery pack is in a safe temperature range, a coolant line is not connected, a charger is not connected, or a low voltage plug is not connected.
11. The computer-implemented method of clause 9, further comprising:
   determining whether one or more conditions are met upon receiving a selection of a new mode after selection of the one selected mode and prior to controlling the power distribution within the aircraft based on the new selected mode, wherein the one or more conditions being met includes at least one of: the aircraft is stationary, the aircraft velocity is below a threshold, or aircraft landing gear is deployed; and
   controlling, via the control circuit, the power distribution within the aircraft based on the new selected mode of operation upon determining the one or more conditions are met.
12. The computer-implemented method of any of clauses 1-11, further comprising:
   detecting whether a charger is connected in one mode of the at least three aircraft modes, but not in another mode of the at least three aircraft modes;
   determining whether one or more conditions for charging are met upon detecting the charger is connected; and
   enabling charging upon detecting the one or more conditions are met.
13. The computer-implemented method of any of clauses 1-12, further comprising:
   detecting whether a low voltage power source is connected in one mode of the at least three aircraft modes, but not in another mode of the at least three aircraft modes; and
   determining whether one or more conditions for accepting low voltage power are met upon detecting the low voltage power source is connected;
   controlling low voltage power to at least one aircraft subsystem upon determining the one or more conditions are met.
14. The computer-implemented method of any of clauses 1-13, further comprising:
   determining whether one or more conditions are met upon receiving one of the at least three aircraft modes and prior to controlling the power distribution within the aircraft,
   wherein the one or more conditions being met includes detecting a low voltage current through the non-propulsion load.
15. The computer-implemented method of any of clauses 1-14, further comprising:
   determining whether one or more conditions are met upon receiving one of the at least three aircraft modes and prior to controlling the power distribution within the aircraft, wherein the one or more conditions being met includes verifying a voltage across the at least one electric propulsion unit.
16. The computer-implemented method of any of clauses 1-15, wherein the user input device is remote from the aircraft.
17. The computer-implemented method of any of clauses 1-16, wherein the control circuit is at least one of a charging control unit or a flight control system.
18. The computer-implemented method of any of clauses 1-17, further comprising:
   wherein in one of the at least three modes of operation the control circuit is a non-flight control system and the non-flight control system receives the selection of the aircraft mode; and
   wherein in another of the at least three modes operation the control circuit is a flight control system and the flight control system receives the selection of the aircraft mode.
19. The computer-implemented method of any of clauses 1-18, wherein controlling power distribution within the aircraft comprises distributing high voltage power differently in each of the at least three aircraft modes of operation.
20. The computer-implemented method of clause 19, wherein controlling power distribution within the aircraft comprises distributing low voltage power in the same manner in at least two of the at least three aircraft modes of operation.
21. The computer-implemented method of clause 19, wherein controlling power distribution within the aircraft comprises distributing low voltage power differently in at least two of the at least three aircraft modes of operation.
22. The computer-implemented method of any of clauses 1-21, wherein controlling high voltage power to the at least one electric propulsion unit comprises controlling high voltage power to at least two electric propulsion units.
23. The computer-implemented method of any of clauses 1-22, wherein controlling high voltage power to the at least one electric propulsion unit comprises controlling high voltage power to all electric propulsion units located on a front section of a wing of the aircraft or an aft section of a wing of the aircraft.
24. The computer-implemented method of any of clauses 1-23, wherein controlling high voltage power to the at least one electric propulsion unit comprises controlling high voltage power to all electric propulsion units on the aircraft.
25. A power control system for an aircraft comprising at least one processor configured to execute instructions to cause the system to perform the method of any one of clauses 1-24.
26. An aircraft comprising the power control system of clause 25.
27. A computer-readable medium storing instructions which, when executed by at least one processor, cause the at least one processor to perform the method of any one of clauses 1-24.
28. A system for an aircraft, the system comprising:
   a battery management unit;
   one or more battery cells configured to supply high voltage power;
   at least one first switching device configured to enable and disable power supply from a charging port to the one or more battery cells;
   at least one second switching device configured to enable and disable a power supply from the one or more battery cells to a non-propulsion load; and
   at least one third switching device configured to enable and disable a power supply from the one or more battery cells to electric propulsion units of the aircraft;
   wherein the battery management unit controls the first, second, and third switching devices based on a selection of one of at least three aircraft modes of operation received from a user input device.
29. The system of clause 28, wherein the battery management unit is configured to command the at least one first, second, and third switching devices to disable the power supply in one of the at least three aircraft modes.
30. The system of clauses 28 or 29, wherein, in one of the at least three aircraft modes, the battery management unit is configured to command the at least one first switching device to enable power supply from the charging port upon determining a charger is connected to the charging port, while the second and third switching devices continue to disable power supply.
31. The system of any of clauses 28-30, wherein the non-propulsion load includes a converter configured to step down power to feed at least one low voltage system of the aircraft.
32. The system of clause 31, wherein, in one of the at least three aircraft modes, the battery management unit is configured to command the at least one second switching device to enable the power supply to the converter and the at least one low voltage system.
33. The system of clause 32, wherein, in one of the at least three aircraft modes, the battery management unit is configured to command the at least one first switching device to enable power supply from the charging port upon determining a charger is connected, while the second switching device enables power supply and the third switching device disables power supply.
34. The system of any of clauses 28-33, wherein the at least one second switching device is further configured to enable power to a cross-link to provide backup power for second battery cells.
35. The system of clause 32, further comprising:
   a first pre charge resistor configured to pre-charge the converter; and
   a first pre-charge switch in series with the first pre-charge resistor, wherein in the one of the at least three aircraft modes, the battery management unit is configured to close the first pre-charge switch and pre-charge the converter prior to commanding the at least one second switching device to enable the power supply to the converter and the at least one low voltage system.
36. The system of any of clauses 28-35, wherein the battery management unit is configured to command the at least one third switching device to enable the power supply from the one or more battery cells to electric propulsion units of the aircraft, when the mode from

the user input device is one of the at least three aircraft modes.
37. The system of any of clauses 28-36,
   a second pre charge resistor configured to pre-charge the electric propulsion units; and
   a second pre-charge switch in series with the second pre-charge resistor, wherein when operating in the one of the selected modes, the battery management unit is configured to close the second pre-charge switch and pre-charge the electric propulsion units prior to commanding the at least one third switching device to enable the power supply to the electric propulsion units of the aircraft.
38. A system for an aircraft, the system comprising:
   a user input device configured to receive an input indicating a mode of operation;
   a power switching device configured to provide power to a controller upon receiving a signal from the user input device, and
   a controller configured to control power to one or more subsystems of the aircraft; and
   wherein the user input device is configured to:
   to not send the signal to the power switching device when the received input indicates a first mode of operation;
   to send the signal to the power switching device when the received input indicates a second mode of operation;
   to send the signal to the power switching device when the received input indicates a third mode of operation; and
   to not send the signal to the power switching device when the received input indicates a fourth mode of operation.
39. The system of clause 38, wherein the power switching device comprises at least one of:
   relay, transistor, contactor, or controller
40. The system of clause 39, wherein the relay comprises a single pole single throw relay.
41. The system of any of clauses 38-40, further comprising a battery pack configured to provide high voltage power to one or more electric propulsion units of the aircraft, wherein:
   the battery pack provides power to the power switching device; and
   a converter steps down the battery pack's high voltage power to power the power switching device.
42. The system of any of clauses 38-41, further comprising a flight control system of the aircraft, wherein:
   the user input device does not provide a signal to the flight control system when the received input indicates the first mode of operation; and
   the user input device provides a signal to the flight control system when the received input indicates the fourth mode of operation.
43. The system of clause 42, wherein the user input device does not provide a signal to the flight control system when the received input indicates the second mode of operation and the third mode of operation.
44. The system of clause 42, wherein:
   the controller provides information on an operation configuration to aircraft battery packs when the received input indicates the second mode of operation and the third mode of operation; and
   the flight control system provides information on an operation configuration to aircraft battery packs when the received input indicates the fourth mode of operation.
45. The system of clause 44, wherein the flight control system is configured to provide information to the aircraft battery packs to supply power to one or more electric propulsion units when the received input indicates the fourth mode of operation.
46. The system of clause 45, wherein the controller is configured to provide information to the aircraft battery packs to supply power to one or more low voltage systems when the

received input indicates the second mode of operation.
47. The system of any of clauses 38-46, wherein:
   the controller is configured to detect a charging plug; and
   the controller is configured to control aircraft battery packs in a charging process upon detection of the charging plug.
48. The system of any of clauses 38-47,
   wherein the aircraft is powered off when the received input indicates the first mode of operation;
   wherein the aircraft is controlled by the controller to accept at least one of: a charge or testing information when the received input indicates the second mode of operation;
   wherein the aircraft is controlled by the controller to power at least one low voltage system when the received input indicates the third mode of operation; and
   wherein the aircraft is controlled by a flight control system of the aircraft to power at least one electric propulsion unit when the received input indicates the fourth mode of operation while the controller remains unpowered.

1-48. (canceled).

49. A computer-implemented method of controlling aircraft power distribution, comprising:
receiving, at a control circuit in an aircraft, a selection of one of at least three aircraft modes of operation from a user input device;
determining, upon receiving the selection of the selected mode and via the control circuit, whether one or more conditions are met; and
controlling, upon determining the one or more conditions are met and via the control circuit, power distribution within the aircraft based on the selected mode of operation, wherein controlling power distribution based on the selected mode of operation comprises:
separately controlling via the control circuit, based on the selected mode of operation, high voltage power to at least one electric propulsion unit and high voltage power to at least one non-propulsion load.

50. The computer-implemented method of claim 49, wherein the user input device is at least one of: a switch, a knob, a button, a lever, a display screen element, or a voice receiver.

51. The computer-implemented method of claim 49, wherein controlling the power distribution within the aircraft comprises controlling at least one switching device.

52. The computer-implemented method of claim 51, wherein the at least one switching device is at least one of a contactor, relay, or transistor.

53. The computer-implemented method of claim 49, wherein in one of the at least three aircraft modes, controlling the power distribution within the aircraft comprises providing no high voltage power to the at least one electric propulsion unit and no high voltage power to the at least one non-propulsion load.

54. The computer-implemented method of claim 49, wherein:
controlling the power distribution within the aircraft based on the selected mode of operation further comprises controlling power to a controller,
wherein the controller is configured to control the high voltage power; and
wherein in at least one of the at least three aircraft modes, controlling the power distribution within the aircraft comprises powering the controller.

55. The computer-implemented method of claim 49, wherein in one of the at least three aircraft modes, controlling the power distribution within the aircraft comprises providing no high voltage power to the at least one electric propulsion unit and providing high voltage power to the at least one non-propulsion load.

56. The computer-implemented method of claim 55, wherein the one or more conditions being met includes at least one of: a pre-charge requirement being met or a continuity requirement being met.

57. The computer-implemented method of claim 49, wherein in one of the at least three aircraft modes, controlling the power distribution within the aircraft comprises providing high voltage power to the at least one electric propulsion unit and high voltage power to the at least one non-propulsion load.

58. The computer-implemented method of claim 57, wherein the one or more conditions being met includes at least one of: a continuity requirement is met for the at least one electric propulsion unit, a pre-charge requirement is met, a battery pack is in a safe temperature range, a coolant line is not connected, a charger is not connected, or a low voltage plug is not connected.

59. The computer-implemented method of claim 57,
wherein the one or more conditions being met includes at least one of: the aircraft is stationary, the aircraft velocity is below a threshold, or aircraft landing gear is deployed.

60. The computer-implemented method of claim 49, further comprising:
detecting whether a charger is connected in one mode of the at least three aircraft modes, but not in another mode of the at least three aircraft modes;
determining whether one or more additional conditions for charging are met upon detecting the charger is connected; and
enabling charging upon detecting the one or more additional conditions are met.

61. The computer-implemented method of claim 49, further comprising:
detecting whether a low voltage power source is connected in one mode of the at least three aircraft modes, but not in another mode of the at least three aircraft modes;
determining whether one or more additional conditions for accepting low voltage power are met upon detecting the low voltage power source is connected; and
controlling low voltage power to at least one aircraft subsystem upon determining the one or more additional conditions are met.

62. The computer-implemented method of claim 49, wherein the one or more conditions being met includes detecting a low voltage current through the non-propulsion load.

63. The computer-implemented method of claim 49, wherein the one or more conditions being met includes verifying a voltage across the at least one electric propulsion unit.

64. The computer-implemented method of claim 49, wherein the user input device is remote from the aircraft.

65. The computer-implemented method of claim 49, wherein the control circuit is at least one of a charging control unit or a flight control system.

66. The computer-implemented method of claim 49, wherein:
in one of the at least three modes of operation the control circuit is a non-flight control system and the non-flight control system receives the selection of the aircraft mode; and
in another of the at least three modes of operation the control circuit is a flight control system and the flight control system receives the selection of the aircraft mode.

67. The computer-implemented method of claim 49, wherein controlling power distribution within the aircraft comprises distributing high voltage power differently in each of the at least three aircraft modes of operation.

68. The computer-implemented method of claim 67, wherein controlling power distribution within the aircraft comprises distributing low voltage power in the same manner in at least two of the at least three aircraft modes of operation.

69. The computer-implemented method of claim 67, wherein controlling power distribution within the aircraft comprises distributing low voltage power differently in at least two of the at least three aircraft modes of operation.

70. The computer-implemented method of claim 49, wherein controlling high voltage power to the at least one electric propulsion unit comprises controlling high voltage power to at least two electric propulsion units.

71. The computer-implemented method of claim 49, wherein controlling high voltage power to the at least one electric propulsion unit comprises controlling high voltage power to all electric propulsion units located on a front section of a wing of the aircraft or an aft section of a wing of the aircraft.

72. The computer-implemented method of claim 71, wherein controlling high voltage power to the at least one electric propulsion unit comprises controlling high voltage power to all electric propulsion units on the aircraft.

73. The computer-implemented method of claim 49, wherein determining whether the one or more conditions are met comprises determining at least one of a discharge requirement of the electric propulsion units is met or no commands are driving the electric propulsion units.

74. The computer-implemented method of claim 49, wherein determining whether the one or more conditions are met comprises determining that both a CAN signal and a discrete signal from a voting component indicate the electric propulsion units may be de-powered.

75. The computer-implemented method of claim 49, wherein determining whether the one or more conditions are met comprises determining that both a first communication link is functional and a second communication link is functional.

76. The computer-implemented method of claim 75, wherein:
the first communication link allows the aircraft to receive flight information; and
the second communication link allows the aircraft to receive a signal to perform at least one of: landing of the aircraft or powering off the aircraft.

77. A system for controlling aircraft power distribution, comprising at least one hardware processor configured to:
receive a selection of one of at least three aircraft modes of operation from a user input device;
determine, upon receiving the selection of the selected mode, whether one or more conditions are met; and
control, upon determining the one or more conditions are met, power distribution within the aircraft based on the selected mode of operation, wherein controlling power distribution based on the selected mode of operation comprises:
separately control, based on the selected mode of operation, high voltage power to at least one electric propulsion unit and high voltage power to at least one non-propulsion load.

78. An aircraft, comprising:
at least one electric propulsion unit;
at least one non-propulsion load;
at least one processor configured to:
receive a selection of one of at least three aircraft modes of operation from a user input device;
determine, upon receiving the selection of the selected mode, whether one or more conditions are met; and
control, upon determining the one or more conditions are met, power distribution within the aircraft based on the selected mode of operation, wherein controlling power distribution based on the selected mode of operation comprises:
separately control, based on the selected mode of operation, high voltage power to the at least one electric propulsion unit and high voltage power to the at least one non-propulsion load.
